(19) United States
(12) Patent Application Publication
(10) Pub. No.: US 2021/0224580 A1
(43) Pub. Date: Jul. 22, 2021

(54) SIGNAL PROCESSING DEVICE, SIGNAL PROCESSING METHOD, AND STORAGE MEDIUM FOR STORING PROGRAM

(71) Applicant: NEC Corporation, Minato-ku, Tokyo (JP)

(72) Inventors: Tatsuya KOMATSU, Tokyo (JP); Reishi KONDO, Tokyo (JP)

(73) Assignee: NEC Corporation, Minato-ku, Tokyo (JP)

(21) Appl. No.: 16/755,300

(22) PCT Filed: Oct. 19, 2017
(86) PCT No.: PCT/JP2017/037886

§ 371 Date: Apr. 10, 2020

(51) Int. Cl. G06K 9/62; G06F 17/14

(52) U.S. Cl. CPC G06K 9/629; G06K 9/623; G06F 17/14

(57) ABSTRACT

A signal processing device according to an exemplary aspect of the present invention includes: at least one memory storing a set of instructions; and at least one processor configured to execute the set of instructions to: extract, from a target signal, a feature amount of the target signal; repeatedly calculate, based on the extracted feature amount, a signal element basis representing a plurality of types of object signals by linear combination, and information of the linear combination, a weight representing an intensity of an object signal included in the target signal, and update information of the linear combination, based on the feature amount, the signal element basis, and the weight, until a predetermined condition is satisfied; derive, based on the weight, information of a target object signal being at least one type of the object signal included in the target signal; and output information of the target object signal.

### TECHNICAL FIELD

The present invention relates to a technique for processing a signal.

### BACKGROUND ART

In the following description, separating a signal represents separating, from a signal in which signals from a plurality of signal sources are mixed, a signal from a predetermined type of signal source. A signal source is, for example, hardware that generates a signal. A signal to be separated is referred to as an object signal. The object signal is a signal from the above-described predetermined type of signal source. A signal source that generates the object signal is referred to as an object signal source. The object signal source is the above-described predetermined type of signal source. A signal from which the object signal is separated is also referred to as a detection target signal. The detection target signal is a signal in which signals from the above-described plurality of signal sources are mixed. A component equivalent to a signal from the object signal source among components of the detection target signal is referred to as a component of an object signal. The component of the object signal is also referred to as an object signal component and an object signal source component.

NPL 1 discloses one example of a technique for separating a signal. In the technique of NPL 1, a feature amount of a component of an object signal to be separated is previously modeled and stored as a basis. In the technique of NPL 1, an input signal in which components of a plurality of object signals are mixed is decomposed, by using the stored basis, into a basis and a weight of each of the components of the plurality of object signals.

### CITATION LIST

### Non Patent Literature

[NPL 1] Dennis L. Sun and Gautham J. Mysore, “Universal speech models for speaker independent single channel source separation,” 2013 IEEE International Conference on Acoustics, Speech and Signal Processing (ICASSP), pp. 141 to 145, 2013

### SUMMARY OF INVENTION

### Technical Problem

As described above, an object signal source is a predetermined type of signal source. The object signal source may not necessarily be one signal source. For example, a plurality of different signal sources of a predetermined type may be an object signal source. An object signal may be a signal generated by the same signal source. The object signal may be a signal generated by any one of a plurality of different signal sources of a predetermined type. The object signal may be a signal generated by one signal source of a predetermined type. Even in a signal from the same signal source, a fluctuation exists in the signal. Even in a signal generated by a signal source of the same type, variations are generated in the signal, for example, depending on an individual difference of the signal source.

Therefore, in a component of the same object signal, a fluctuation and variations exist. In the technique of NPL 1, when a fluctuation is large, it is difficult to accurately separate an object signal by using the same basis, even when the object signal is generated from the same object signal source. It is also difficult to accurately separate an object signal by using the same basis, even when the object signal is generated from an object signal source of the same type, when, for example, variations of an object signal exist due to a variation of object signal sources. When a fluctuation exists, it is necessary to store a basis different for each object signal that varies due to the fluctuation. When variations exist, it is necessary to store a basis different for each variation of an object signal. Therefore, when an object signal is modeled as a basis, the number of bases is increased according to a magnitude of a fluctuation and the number of variations. Therefore, in order to model various actual object signal sources as bases, it is necessary to store an enormous number of bases. Therefore, an enormous memory cost is required.

An object of the present invention is to provide a signal processing technique capable of acquiring information of a modeled object signal component at low memory cost even when a variation of object signals is large.

### Solution to Problem

A signal processing device according to an exemplary aspect of the present invention includes: feature extraction means for extracting, from a target signal, a feature amount representing a feature of the target signal; analysis means for repeatedly calculating, based on the extracted feature amount, a signal element basis representing a plurality of types of object signals by linear combination, and information of the linear combination, a weight representing an intensity of each of the plurality of object signals included in the target signal, and updating information of the linear combination, based on the feature amount, the signal element basis, and the weight, until a predetermined condition is satisfied; processing means for deriving, based on the weight, information of a target object signal being at least one type of the object signal included in the target signal; and output means for outputting information of the target object signal.

A signal processing method according to an exemplary aspect of the present invention includes: extracting, from a target signal, a feature amount representing a feature of the target signal; repeatedly calculating, based on the extracted feature amount, a signal element basis representing a plurality of types of object signals by linear combination, and information of the linear combination, a weight representing an intensity of each of the plurality of object signals included in the target signal, and updating information of the linear combination, based on the feature amount, the signal element basis, and the weight, until a predetermined condition is satisfied; deriving, based on the weight, information of a target object signal being at least one type of the object signal included in the target signal; and outputting information of the target object signal.

A storage medium according to an exemplary aspect of the present invention stores a program causing a computer to execute: feature extraction processing of extracting, from a target signal, a feature amount representing a feature of the target signal; analysis processing of repeatedly calculating, based on the extracted feature amount, a signal element basis representing a plurality of types of object signals by linear combination, and information of the linear combination, a weight representing an intensity of each of the plurality of object signals included in the target signal, and updating information of the linear combination, based on the feature amount, the signal element basis, and the weight, until a predetermined condition is satisfied; deriving processing of deriving, based on the weight, information of a target object signal being at least one type of the object signal included in the target signal; and output processing of outputting information of the target object signal. An exemplary aspect of the present invention can be achieved by the program stored in the storage medium described above.

### Advantageous Effects of Invention

The present invention has an advantageous effect that, even when a variation of object signals is large, information of a component of a modeled object signal can be acquired at low memory cost.

### BRIEF DESCRIPTION OF DRAWINGS

FIG. 1 is a block diagram illustrating an example of a configuration of a signal separation device according to a first example embodiment of the present invention.

FIG. 2 is a flowchart illustrating an example of an operation of a signal separation device according to the first, a third, and a fifth example embodiment of the present invention.

FIG. 3 is a block diagram illustrating a configuration of a signal detection device according to a second example embodiment of the present invention.

FIG. 4 is a flowchart illustrating an example of an operation of a signal detection device according to the second, a fourth, and a sixth example embodiment of the present invention.

FIG. 5 is a block diagram illustrating an example of a configuration of the signal separation device according to the third example embodiment of the present invention.

FIG. 6 is a flowchart illustrating an example of an operation of a signal separation device according to the third, fourth, and fifth example embodiments of the present invention.

FIG. 7 is a block diagram illustrating an example of a configuration of the signal detection device according to the fourth example embodiment of the present invention.

FIG. 8 is a block diagram illustrating an example of a configuration of the signal separation device according to the fifth example embodiment of the present invention.

FIG. 9 is a flowchart illustrating an example of an operation of a signal separation device according to the fifth and sixth example embodiments of the present invention.

FIG. 10 is a diagram illustrating an example of a configuration of the signal detection device according to the sixth example embodiment of the present invention.

FIG. 11 is a block diagram illustrating an example of a configuration of a signal processing device according to a seventh example embodiment of the present invention.

FIG. 12 is a flowchart illustrating an example of an operation of the signal processing device according to the seventh example embodiment of the present invention.

FIG. 13 is a block diagram illustrating an example of a hardware configuration of a computer capable of achieving a signal processing device according to example embodiments of the present invention.

FIG. 14 is a block diagram illustrating an example of a configuration of a signal separation device implemented by using a related art.

### EXAMPLE EMBODIMENT

### Related Art

Before example embodiments of the present invention are described, a technique for separating a signal that is a related art for both a technique according to the example embodiments of the present invention and the technique described in NPL 1 is described.

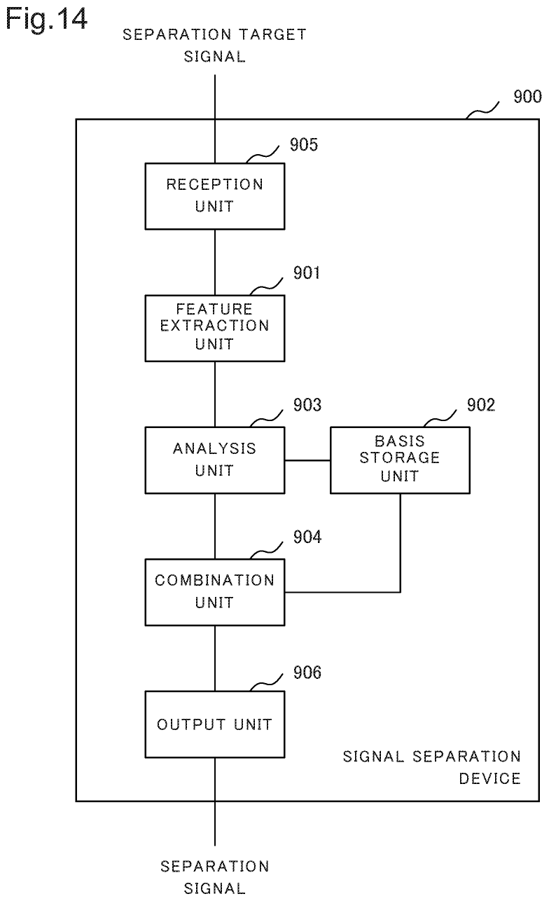

FIG. 14 is a block diagram illustrating an example of a configuration of a signal separation device 900 implemented by using the related art. The signal separation device 900 includes a feature extraction unit 901, a basis storage unit 902, an analysis unit 903, a combination unit 904, a reception unit 905, and an output unit 906.

The reception unit 905 receives a separation target signal including, as a component, an object signal from an object signal source. A separation target signal is a signal measured, for example, by a sensor.

The feature extraction unit 901 receives, as input, a separation target signal, extracts a feature amount from the received separation target signal, and transmits the extracted feature amount to the analysis unit 903.

The basis storage unit 902 stores a feature amount basis of an object signal source. The basis storage unit 902 may store a feature amount basis of each of a plurality of object signals.

The analysis unit 903 receives, as input, a feature amount transmitted from the feature extraction unit 901 and reads a feature amount basis stored in the basis storage unit 902. The analysis unit 903 calculates an intensity (weight) of a feature amount basis of an object signal in the received feature amount. The analysis unit 903 may calculate, in the received feature amount, an intensity (weight) of each feature amount basis for each of object signals. The analysis unit 903 transmits the calculated weight, for example, to the combination unit 904, for example, in a form of a weighting matrix.

The combination unit 904 receives a weight, for example, in a form of a weighting matrix from the analysis unit 903. The combination unit 904 reads a feature amount basis stored in the basis storage unit 902. The combination unit 904 generates a separation signal, based on a weight received from the analysis unit 903, for example, in a form of a weighting matrix, and a feature amount basis stored in the basis storage unit 902. Specifically, the combination unit 904 calculates a series of feature amounts of an object signal by, for example, linearly combining a weight and a feature amount basis. The combination unit 904 generates, from the acquired series of feature amounts of the object signal, a separation signal of the object signal and transmits the generated separation signal to the output unit 906. As in an example described below, when extraction of a feature amount from a signal by the feature extraction unit 901 is equivalent to application of a predetermined conversion to the signal, the combination unit 904 may generate a separation signal by applying inverse conversion of the predetermined conversion to a series of feature amounts of an object signal.

The output unit 906 receives a separation signal from the combination unit 904 and outputs the received separation signal.

In an example of the following description, a type of a signal generated by a signal source is an acoustic signal. It is assumed that a separation target signal is an acoustic signal x(t). Herein, t is an index representing a time. Specifically, t is a time index of an acoustic signal sequentially input in which a predetermined time (e.g. a time at which input to a device is performed) is designated as an original t=0. x(t) is a series of digital signals acquired by applying analog to digital conversion to an analog signal recorded by a sensor such as a microphone. In an acoustic signal recorded by a microphone installed in an actual environment, components generated from various sound sources in the actual environment are mixed. When, for example, an acoustic signal is recorded by a microphone installed in an office, a signal in which components of acoustics (e.g. a conversational voice, a keyboard sound, an air-conditional sound, and a footstep) from various sound sources existing in the office are mixed is recoded by the microphone. A signal acquirable via observation is an acoustic signal x(t) representing an acoustic in which acoustics from various sound sources are mixed. A sound source generating an acoustic included in an acoustic signal in which a signal from a sound source is acquired is unknown. An intensity of an acoustic from each sound source included in an acquired sound source is unknown. In the related art, an acoustic signal representing an acoustic from a sound source that may be mixed with an acoustic signal recorded in an actual environment is previously modeled as an object acoustic signal (i.e., the above-described object signal), by using a basis of a feature amount component. The signal separation device 900 receives an acoustic signal x(t), separates the received acoustic signal into components of an object acoustic included in the acoustic signal, and outputs the separated components of the object acoustic.

The feature extraction unit 901 receives, as input, for example, x(t) having a predetermined time width (e.g. two seconds when a signal is an acoustic signal). The feature extraction unit 901 calculates, based on the received x(t), for example, a feature amount matrix Y=[y(1), . . . , y(L)] being a K×L matrix as a feature amount and outputs the calculated Y. A feature amount is exemplarily described later. A vector y(j) (j=1, . . . , L) is a vector representing a K-dimensional feature amount in a time frame j being a j-th time frame. A value of K may be previously determined. L is the number of time frames of the received x(t). A time frame is a signal having a length of a unit time width (interval) when a feature amount vector y(j) is extracted from x(t). When, for example, x(t) is an acoustic signal, an interval is generally set to be approximately 10 milliseconds (ms). When, for example, as a criterion, j is designated as j=1 when t=0, a relation between j and t is t=10 ms when j=2, and t=20 ms when j=3, . . . . A vector y(j) is a feature amount vector of x(t) at a time t related to a time frame j. A value of L is the number of time frames included in a signal x(t). When a unit of a time width of a time frame is set as 10 ms and x(t) having a length of 2 seconds is received, L is 200. When a signal x(t) is an acoustic signal, an amplitude spectrum acquired by applying short-time Fourier transform to x(t) is frequently used as a feature amount vector y(j). In another example, a logarithmic frequency amplitude spectrum acquired by applying wavelet transform to x(t) may be used as a feature amount vector y(j).

The basis storage unit 902 stores a feature amount of an object signal, for example, as a feature amount basis matrix in which a feature amount basis of an object signal is represented by a matrix. When the number of feature amount bases of an object signal source is S, a feature amount basis matrix being a matrix representing S feature amount bases of the object signal source is represented as W=[W_1, . . . , W_S]. The basis storage unit 902 may store, for example, a feature amount basis matrix W. A matrix W_s (s=1, . . . , S) is a K×n(s) matrix combined with feature amount bases of an object signal source s being an s-th object signal source. Herein, n(s) represents the number of feature amount bases of an object signal source s. For simplification, as a simple example, a case where a signal is an acoustic, an object signal source (i.e., an object sound source) is a piano, and an object signal is a sound of a piano is described. When seven sounds being do, re, mi, fa, sol, la, si generated by a specific piano A are modeled as an object signal (i.e., an object acoustic) from an object sound source being a “piano A”, the number of feature amount bases n (piano A) is represented as n (piano A)=7. A feature amount basis matrix W_(piano A) is a K×7 matrix W_(piano_A)=[w_(do), . . . , w_(si)] in which feature amount vectors of sounds are combined.

The analysis unit 903 decomposes a feature amount matrix Y output by the feature extraction unit 901 into a product Y=WH of a feature amount basis matrix W and a weighting matrix H having R rows and L columns stored in the basis storage unit 902 and outputs the acquired weighting matrix H.

Herein, R is a parameter representing the number of columns of W and is a sum of n(s) with respect to every s={1, . . . , S}. H represents a weight indicating to what extent each basis of W is included in a component y(j) in each frame (i.e., 1 to L) of Y. When a vector in a j-th column of H is h(j), h(j)=[h_1(j)T, . . . , h_S(j)T]T is satisfied. Herein, h_s(j) (s=1, . . . , S) is an n(s)-dimensional vertical vector representing a weight in a time frame j of a feature amount basis W_s of an object sound source s. T represents transposition of a vector and a matrix. The analysis unit 903 may calculate a weighting matrix H by using independent component analysis (ICA), principal component analysis (PCA), non-negative matrix factorization (NMF), sparse coding or the like each being a well-known matrix decomposition method. In an example described below, the analysis unit 903 calculates a weighting matrix H by using NMF.

The combination unit 904 generates a series of feature amounts by linearly combining a weight and a feature amount basis with respect to each object sound source, by using a weighting matrix H output by the analysis unit 903 and a feature amount basis matrix W of a sound source stored in the basis storage unit 902. The combination unit 904 converts the generated series of feature amounts and thereby generates a separation signal x_s(t) of a component of an object sound source s with respect to s={1, . . . , S}. The combination unit 904 outputs the generated separation signal x_s(t). It is conceivable that, for example, a product Y_s=W_s·H_s of a feature amount basis W_s of an object sound source s included in a feature amount basis matrix W corresponding to the object sound s and H_s=[h_s(1), . . . , h_s(L)] being a weight of a feature amount basis of the object sound source s included in a weighting matrix H is a series of feature amounts of components of a signal representing an acoustic from the object sound source s in an input signal x(t). In the following, a component of a signal representing an acoustic from an object sound source s is also simply referred to as a component of an object sound source s. A component x_s(t) of an object sound source s included in an input signal x(t) is acquired by applying, to Y_s, inverse conversion (inverse Fourier transform in a case of short-time Fourier transform) of feature amount conversion used for calculating a feature amount matrix Y by the feature extraction unit 901.

The above indicates the related art. In the above-described example, a specific piano A was designated as an object sound source and as a feature amount of the specific piano A, W_(piano A) was defined. However, actually, a sound of a piano has an individual difference. Therefore, in order to more accurately separate an object signal by using the above-described method when a “sound of a piano” is an object sound source, it is necessary to store a feature amount basis matrix W including feature amount vectors of sounds of various individual pianos. When an object sound source is more general as in a “footstep” or a “breaking sound of glass”, in order to more accurately separate an object signal by using the above-described method, it is necessary to store feature amount vectors for enormous variations of a footstep and a breaking sound of glass. In this case, a feature amount basis matrix W_(footstep) and a feature amount basis matrix W_(breaking sound of glass) are matrices having an enormous number of columns. Therefore, a memory cost for storing a feature amount basis matrix W is enormous. One object of example embodiments of the present invention described below is that, even when there are enormous variations of an object signal, a component of an object sound source is separated from a signal in which object signals are mixedly recorded, while reducing a required memory cost.

### First Example Embodiment

Next, a first example embodiment of the present invention is described in detail with reference to drawings.

<Configuration>

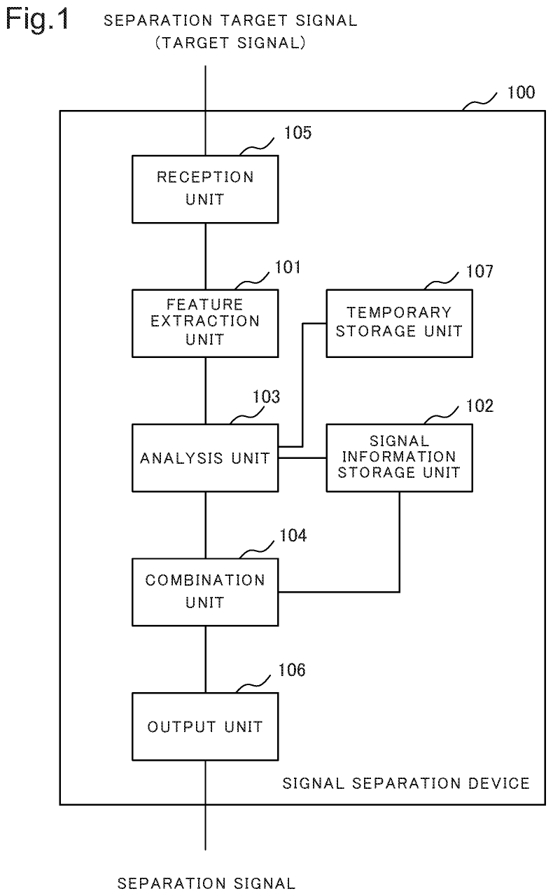

FIG. 1 is a block diagram illustrating an example of a configuration of a signal separation device 100 according to the present example embodiment. The signal separation device 100 includes a feature extraction unit 101, a signal information storage unit 102, an analysis unit 103, a combination unit 104, a reception unit 105, an output unit 106, and a temporary storage unit 107.

The reception unit 105 receives a separation target signal, for example, from a sensor. A separation target signal is a signal acquired by applying AD conversion to an analog signal acquired as a result of measurement by a sensor. A separation target signal may include an object signal from at least one object signal source. A separation target signal is simply expressed also as a target signal.

The feature extraction unit 101 receives, as input, a separation target signal and extracts a feature amount from the received separation target signal. The feature extraction unit 101 transmits the feature amount extracted from the separation target signal to the analysis unit 103. A feature amount extracted by the feature extraction unit 101 may be the same as a feature amount extracted by the feature extraction unit 901 described above. Specifically, when a separation target signal is an acoustic signal, the feature extraction unit 101 may extract, as a feature amount, an amplitude spectrum acquired by applying short-time Fourier transform to a separation target signal. The feature extraction unit 101 may extract, as a feature amount, a logarithmic frequency amplitude spectrum acquired by applying wavelet transform to a separation target signal.

The signal information storage unit 102 stores a signal element basis in which an element being a base of an object signal is modeled and an initial value of combination information indicating a combination manner for combining signal element bases in such a way as to acquire a signal corresponding to an object signal. A signal element basis is, for example, a partial set linearly independent in a space established by a feature amount extracted from an object signal to be targeted. An object signal to be targeted is an object signal to be processed. According to the present example embodiment, an object signal to be targeted is specifically an object signal to be separated. According to other example embodiments, an object signal to be targeted may be an object signal to be detected. A signal element basis can express, by linear combination, all feature amounts extracted from an object signal to be targeted. A signal element basis may be represented, for example, by a vector. In this case, combination information may be represented, for example, by a combination coefficient of each signal element basis. A signal element basis is described in detail later. The signal information storage unit 102 may store, in a form of a matrix, a signal element basis and combination information with respect to each of a plurality of object signals. In other words, the signal information storage unit 102 may store a signal element basis matrix representing a signal element basis in which an element being a base of a plurality of object signals is modeled. The signal information storage unit 102 may further store an initial value of a combination matrix representing a combination manner for combining a signal element basis in such a way as to generate a signal corresponding to an object signal, with respect to each object signal. In this case, a signal element basis matrix and a combination matrix may be set in such a way as to generate a matrix representing feature amounts of a plurality of object signals by multiplying the signal element basis matrix and the combination matrix.

The analysis unit 103 receives a feature amount transmitted from the feature extraction unit 101 and reads a stored signal element basis and a stored initial value of combination information (e.g. a signal element basis matrix and an initial value of a combination matrix) from the signal information storage unit 102. The analysis unit 103 calculates, based on the received feature amount and the read signal element basis and combination information, a weight representing a magnitude of contribution of an object signal in the received feature amount. A method of calculating a weight is described in detail later. The analysis unit 103 may first calculate a weight, based on a feature amount, a signal element basis, and an initial value of combination information. The analysis unit 103 further updates, when a predetermined condition is not satisfied, combination information, based on a feature amount, a signal element basis, and the calculated weight. A predetermined condition may be, for example, the number of updates of combination information. The analysis unit 103 may determine, when, for example, the number of updates of combination information reaches a predetermined number, that a predetermined condition is satisfied. A predetermined condition is described in detail later. The analysis unit 103 may store updated combination information in the temporary storage unit 107. The analysis unit 103 further calculates a weight, based on a feature amount, a signal element basis, and updated combination information. The analysis unit 103 may use, when further calculating a weight, updated combination information stored in the temporary storage unit 107. The analysis unit 103 may repeatedly update combination information and calculate a weight until a predetermined condition is satisfied. The analysis unit 103 transmits, when the predetermined condition is satisfied, a calculated weight and latest combination information, for example, to the combination unit 104. Latest combination information is combination information when a predetermined condition is satisfied. The analysis unit 103 may generate, for example, a weight matrix representing a calculated weight and a combination matrix representing combination information and transmit the generated weight matrix and combination matrix.

In description of the present example embodiment and description of other example embodiments, the analysis unit 103 determines, after calculating a weight, whether a predetermined condition is satisfied. A timing of determining whether a predetermined condition is satisfied is not limited to this example. The analysis unit 103 may determine whether a predetermined condition is satisfied, not after calculating a weight matrix but after updating combination information. The analysis unit 103 may determine whether a predetermined condition is satisfied, after calculating a weight matrix and in addition, after updating combination information. The analysis unit 103 may execute, when a predetermined condition is not satisfied, the following operation when repeatedly calculating a weight and updating combination information. The analysis unit 103 may transmit, when a predetermined condition is satisfied, a weight and combination information to the combination unit 104.

The combination unit 104 receives, for example, a weight transmitted as a weighting matrix and combination information transmitted as a combination matrix from the analysis unit 103 and reads a signal element basis stored, for example, as a signal element basis matrix, in the signal information storage unit 102. The combination unit 104 generates a separation signal of an object signal, based on a weight, a signal element basis, and combination information. Specifically, the combination unit 104 generates a separation signal of an object signal, for example, based on a series of feature amounts of an object signal source acquired by combining signal element bases, based on a signal element basis matrix and a combination matrix. A method of generating a separation signal is described in detail later. The combination unit 104 transmits the generated separation signal to the output unit 106.

The output unit 106 receives the generated separation signal and outputs the received separation signal.

The temporary storage unit 107 stores combination information updated by the analysis unit 103. As described above, combination information is represented, for example, by the above-described combination matrix. For example, the signal information storage unit 102 may operates as the temporary storage unit 107. The analysis unit 103 may operate as the temporary storage unit 107.

Hereinafter, a specific example of processing executed by the signal separation device 100 is described in detail.

The feature extraction unit 101 extracts, similarly to the feature extraction unit 901 described above, a feature amount from a separation target signal and transmits the extracted feature amount, for example, as a feature amount matrix Y.

The signal information storage unit 102 stores a signal element basis matrix G and an initial value of a combination matrix C. A signal element basis matrix G represents a signal element basis in which a feature amount of an element (signal element) being a base of a plurality of object signals is modeled. A combination matrix C represents a combination manner for combining signal element bases included in a signal element basis matrix G in such a way as to generate a signal corresponding to an object signal with respect to each of a plurality of object signals.

The analysis unit 103 receives, as input, a feature amount matrix Y and combination matrix C transmitted by the feature extraction unit 101 and reads a signal element basis matrix G stored in the signal information storage unit 102. The analysis unit 103 decomposes, by using a signal element basis matrix G and an initial value of a combination matrix C, a feature amount matrix Y in such a way that Y=GCH is satisfied and calculates a weight matrix H. When a predetermined condition is not satisfied, the analysis unit 103 updates, as described below, a combination matrix C by using a signal element basis matrix G, a latest combination matrix C, and the calculated matrix H. The analysis unit 103 calculates, for example, as described below, a signal element basis matrix G, the updated combination matrix C, and a weight matrix H. At that time, the analysis unit 103 may update a matrix H by further using a previously calculated matrix H. The analysis unit 103 repeatedly updates a matrix C and calculates a matrix H until a predetermined condition is satisfied. When a predetermined condition is satisfied, the analysis unit 103 transmits an acquired matrix H and matrix C. Decomposition of a feature amount matrix Y is described in detail in description of a third example embodiment to be described later.

A matrix H corresponds to a weight of each object signal in a feature amount matrix Y. In other words, a matrix H is a weighting matrix representing a weight of each object signal in a feature amount matrix Y.

The combination unit 104 receives a weighting matrix H and a combination matrix C transmitted by the analysis unit 103 and reads a signal element basis matrix G stored in the signal information storage unit 102. The combination unit 104 combines, by using the received weighting matrix H and combination matrix C and the read signal element basis matrix G, components of an object signal with respect to each object sound source, and thereby generates a series of feature amounts of an object signal with respect to each object sound source. The combination unit 104 further applies, to a series of feature amounts, inverse conversion of conversion for extracting a feature amount from a signal and thereby generates a separation signal x_s(t) in which a component of an object signal from an object sound source s is separated from a separation target signal. The combination unit 104 transmits the generated separation signal x_s(t) to the output unit 106. The combination unit 104 may transmit a feature amount matrix Y_s, instead of a separation signal x_s(t) of an object sound source s. The combination unit 104 does not need to output a separation signal x_s(t) of every s (i.e., every object sound source s a signal element basis of which is stored). The combination unit 104 may output, for example, only a separation signal x_s(t) of an object sound source previously specified.

<Operation>

Next, an operation of the signal separation device 100 according to the present example embodiment is described in detail with reference to a drawing.

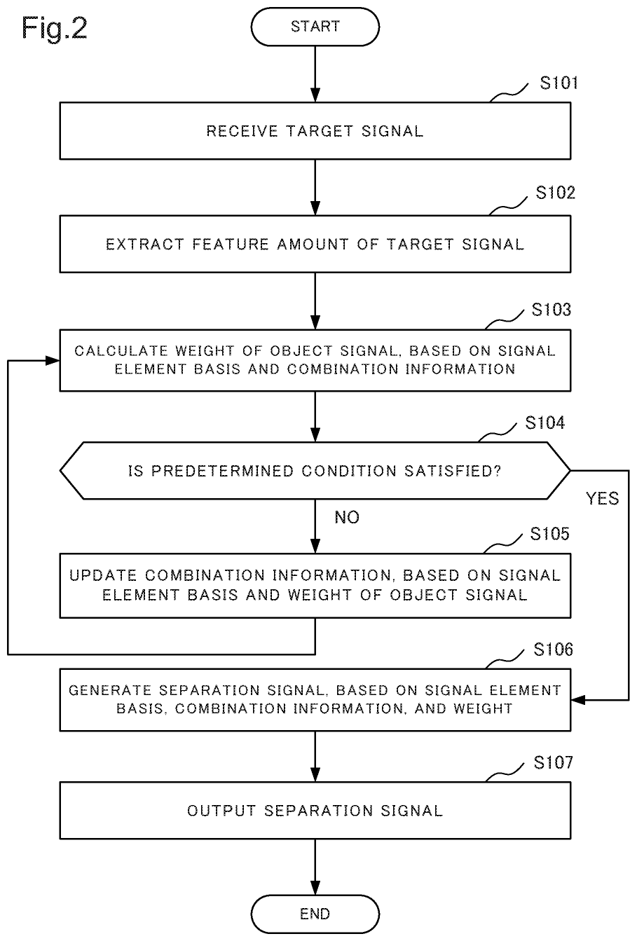

FIG. 2 is a flowchart illustrating an example of an operation of the signal separation device 100 according to the present example embodiment.

According to FIG. 2, first, the reception unit 105 receives a target signal (i.e., the above-described detection target signal) (step S101). The feature extraction unit 101 extracts a feature amount of the target signal (step S102). The analysis unit 103 calculates a weight of an object signal in the target signal, based on the extracted feature amount and a feature amount basis stored in the signal information storage unit 102 (step S103). A weight of an object signal in a target signal represents, for example, an intensity of a component of an object signal included in a target signal. When a predetermined condition is not satisfied (NO in step S104), the analysis unit 103 repeats an operation of step S105 and step S103 until the predetermined condition is satisfied. In other words, the analysis unit 103 updates combination information, based on a signal element basis and a weight of an object signal (step S105). The signal separation device 100 executes an operation from step S103. In other words, the analysis unit 103 calculates a weight of an object signal, based on a signal element basis and the updated combination information (step S103).

When the predetermined condition is satisfied (YES in step S104), the signal separation device 100 next executes an operation of step S106.

The combination unit 104 generates a separation signal, based on a feature amount basis, combination information, and a weight (step S106). The output unit 106 outputs the generated separation signal (step S107).

### Advantageous Effect

In a method of modeling, based on a feature amount basis, all variations of an object signal used in NPL 1 and the like, a feature amount basis matrix becomes larger as variations of an object signal increase, and therefore an enormous memory cost is required. According to the present example embodiment, an object signal is modeled as a combination of signal element bases each being a basis of a finer unit for expressing all object signals to be separated. Therefore, variations of an object signal are expressed as variations of a method of combining bases. Therefore, even when variations are increased, only a lower dimensional combination matrix may be increased, instead of a feature amount basis itself of an object signal. According to the present example embodiment, a required memory cost is lower than a memory cost required in the technique of NPL 1. Therefore, according to the present example embodiment, a memory cost required for a basis in which a feature amount of a component of an object signal is modeled is low, and therefore a signal can be decomposed while a required memory cost is reduced.

### Second Example Embodiment

Next, a second example embodiment of the present invention is described in detail with reference to a drawing.

<Configuration>

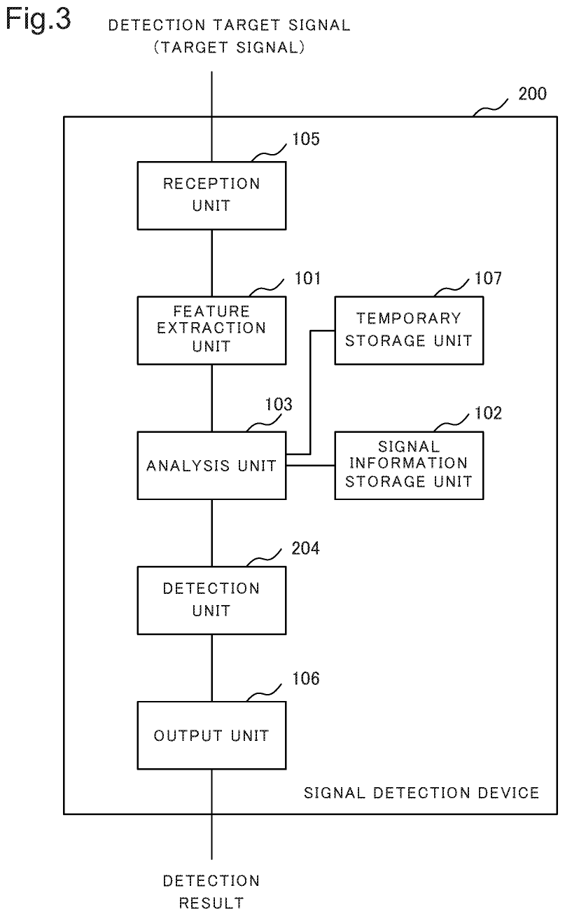

FIG. 3 is a block diagram illustrating a configuration of a signal detection device 200 according to the present example embodiment. According to FIG. 3, the signal detection device 200 includes a feature extraction unit 101, a signal information storage unit 102, an analysis unit 103, a detection unit 204, a reception unit 105, an output unit 106, and a temporary storage unit 107.

The feature extraction unit 101, the signal information storage unit 102, the analysis unit 103, the reception unit 105, the output unit 106, and the temporary storage unit 107 according to the present example embodiment each may be the same as a component assigned with the same name and reference sign according to the first example embodiment, except a difference described below. The reception unit 105 receives a detection target signal. A detection target signal is also simply referred to as a target signal. A detection target signal may be the same as a separation target signal of the first example embodiment. The analysis unit 103 transmits a calculated weight, for example, as a weighting matrix H.

The detection unit 204 receives, as input, a weight transmitted, for example, as a weighting matrix H from the analysis unit 103. The detection unit 204 detects an object signal included in a detection target signal, based on the received weighting matrix H. Each column of a weighting matrix H corresponds to a weight of each object sound source included in any time frame of a feature amount matrix Y of a detection target signal. Therefore, the detection unit 204 may detect which object signal source exists in each time frame of Y, for example, by comparing a value of each element of H with a threshold. When, for example, a value of an element of H is larger than a threshold, the detection unit 204 may determine that an object signal from an object sound source identified by the element is included in a time frame of a detection target signal identified by the element. When a value of an element of H is equal to or smaller than a threshold, the detection unit 204 may determine that an object signal from an object sound source identified by the element is not included in a time frame of a detection target signal identified by the element. The detection unit 204 may detect which object signal source exists in each time frame of Y by using a discriminator using a value of each element of H as a feature amount. As a learning model of a discriminator, for example, a support vector machine (SVM), a Gaussian mixture model (GMM) or the like is applicable. A discriminator may be previously provided by learning. The detection unit 204 may transmit, as a detection result, for example, a data value identifying an object signal included in each time frame. The detection unit 204 may transmit, as a detection result, a matrix Z having S rows and L columns (S is the number of object signal sources and L is the total number of time frames of Y) in which as output, for example, whether an object signal from each object signal source s exists in each time frame of Y is represented by different values (e.g. 1 and 0). A value of an element of a matrix Z, i.e., a value representing whether an object signal exists may be a score having a continuous value (e.g. a score taking a real value between equal to or larger than 0 and equal to or smaller than 1) indicating a likelihood of presence of an object signal.

The output unit 106 receives a detection result from the detection unit 204 and outputs the received detection result.

<Operation>

Next, an operation of the signal detection device 200 according to the present example embodiment is described in detail with reference to a drawing.

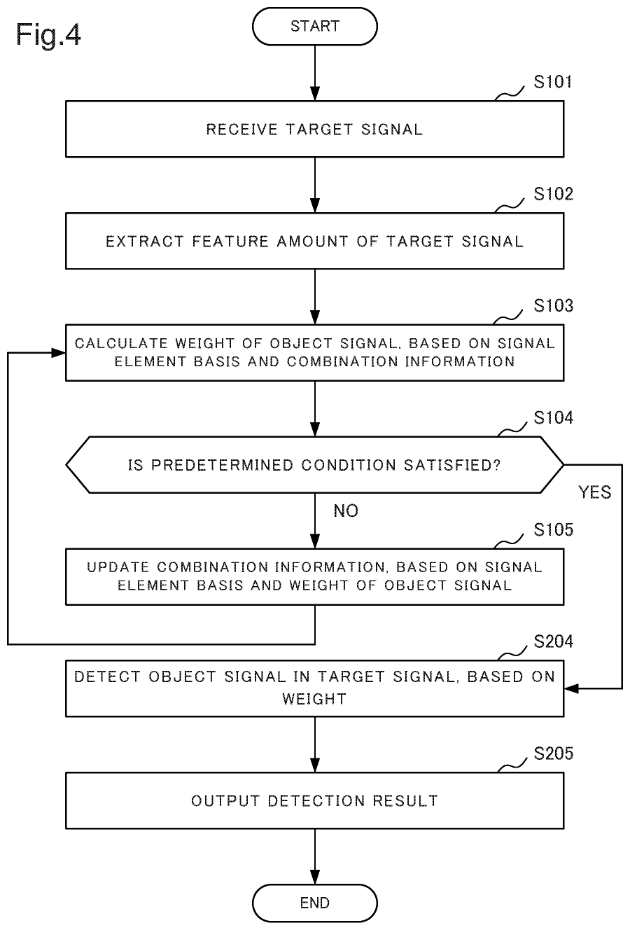

FIG. 4 is a flowchart illustrating an example of an operation of the signal detection device 200 according to the present example embodiment. An operation from step S101 to step S103 illustrated in FIG. 4 is the same as the operation from step S101 to step S105 of the signal separation device 100 according to the first example embodiment illustrated in FIG. 1.

In step S204, the detection unit 204 detects an object signal in a target signal, based on a calculated weight (step S204). In other words, the detection unit 204 determines, based on a calculated weight, whether each object signal exists in a target signal. The detection unit 204 outputs a detection result representing whether each object signal exists in a target signal (step S205).

### Advantageous Effect

In a method of modeling, based on a feature amount basis, all variations of an object signal used in NPL 1 and the like, a feature amount basis matrix becomes larger as variations of an object signal increase, and therefore an enormous memory cost is required. According to the present example embodiment, an object signal is modeled as a combination of signal element bases each being a basis of a finer unit for expressing all object signals to be separated. Therefore, variations of an object signal are expressed as variations of a method of combining bases. Therefore, even when variations are increased, only a lower dimensional combination matrix may be increased, instead of a feature amount basis itself of an object signal. According to the present example embodiment, a required memory cost is lower than a memory cost required in the technique of NPL 1. Therefore, according to the present example embodiment, a memory cost required for a basis in which a feature amount of a component of an object signal is modeled is low, and therefore a signal can be detected while a required memory cost is reduced.

### Third Example Embodiment

Next, a third example embodiment of the present invention is described in detail with reference to drawings.

<Configuration>

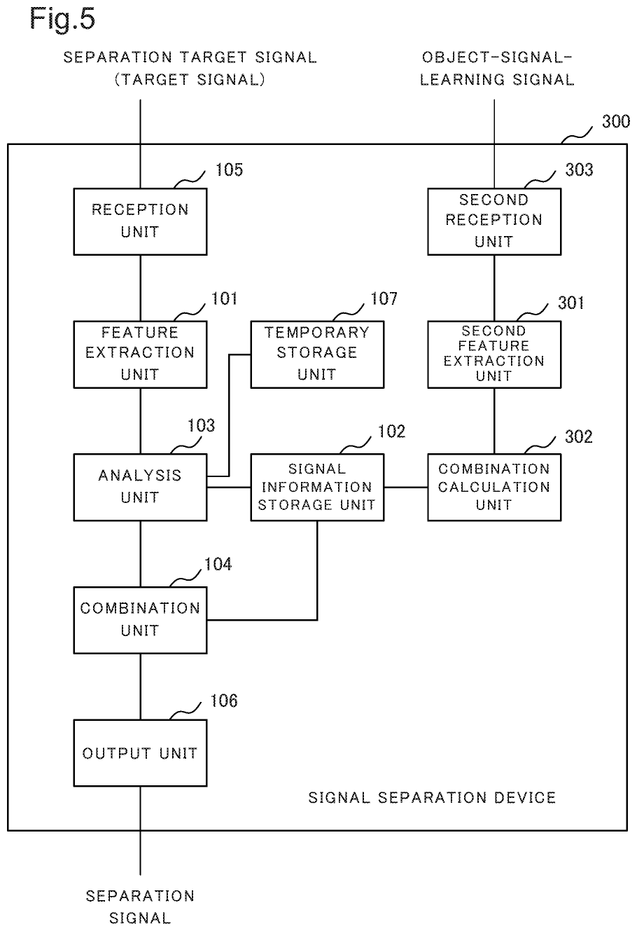

FIG. 5 is a block diagram illustrating an example of a configuration of a signal separation device 300 according to the present example embodiment. According to FIG. 5, the signal separation device 300 includes a feature extraction unit 101, a signal information storage unit 102, an analysis unit 103, a combination unit 104, a reception unit 105, an output unit 106, and a temporary storage unit 107. The signal separation device 300 further includes a second feature extraction unit 301, a combination calculation unit 302, and a second reception unit 303. The feature extraction unit 101, the signal information storage unit 102, the analysis unit 103, the combination unit 104, the reception unit 105, the output unit 106, and the temporary storage unit 107 of the signal separation device 300 each operate similarly to a unit assigned with the same name and number of the signal separation device 100 according to the first example embodiment.

The second reception unit 303 receives an object-signal-learning signal, for example, from a sensor. An object-signal-learning signal is a signal in which an intensity of an included object signal is known. Object-signal-learning data may be a signal recorded in such a way that, for example, one time frame includes only one object signal.

The second feature extraction unit 301 receives, as input, a received object-signal-source-learning signal and extracts a feature amount from the received object-signal-source-learning signal. A feature amount extracted from an object-signal-source-learning signal is also referred to as a learning feature amount. The second feature extraction unit 301 transmits the generated learning feature amount to the combination calculation unit 302, as a learning feature amount matrix.

The combination calculation unit 302 calculates, from a learning feature amount, a signal element basis and combination information. Specifically, the combination calculation unit 302 calculates, from a learning feature amount matrix representing a learning feature amount, a signal element basis matrix representing a signal element basis and a combination matrix representing combination information. In this case, the combination calculation unit 302 may decompose a learning feature amount matrix into a signal element basis matrix and a combination matrix, for example, by using ICA, PCA, NMF, or sparse coding. One example of a method of calculating a signal element basis and combination information by decomposing a learning feature amount matrix into a signal element basis matrix and a combination matrix is described in detail below. The combination calculation unit 302 transmits a derived signal element basis and combination information, for example, as a signal element basis matrix and a combination matrix. The combination calculation unit 302 may store a signal element basis matrix and a combination matrix in the signal information storage unit 102.

In the following, the signal separation device 300 is specifically described.

In an example described in the following, similarly to the description of the prior art, a type of a signal generated by a signal source is an acoustic signal.

The second feature extraction unit 301 receives, as input, an object-signal-learning signal and extracts a learning feature amount from the object-signal-learning signal. The second feature extraction unit 301 transmits, as a learning feature amount, for example, a learning feature amount matrix Y_0 having K rows and L_0 columns to the combination calculation unit 302. K is the number of dimensions of a feature amount and L_0 is the total number of time frames of an input learning signal. As described above, as a feature amount in a case of an acoustic signal, an amplitude spectrum acquired by applying short-time Fourier transform is frequently used. The second feature extraction unit 301 according to the present example embodiment extracts, as a feature amount, for example, an amplitude spectrum acquired by applying short-time Fourier transform to an object-signal-learning signal.

An object-signal-learning signal is a signal for learning a feature of an object signal to be separated. When, for example, there are three types of object signals which are “(a) piano sound, (b) conversational voice, and (c) footstep”, a signal of a piano sound, a signal of a conversational voice, and a signal of a footstep are sequentially input to the signal separation device 300, as object-signal-learning signals. Y_0 is a matrix in which feature amount matrices extracted from signals of object sound sources are combined in a time frame direction. When object-signal learning object signals are the above-described three types of object signals, Y_0=[Y_a, Y_b, Y_c] is satisfied. A matrix Y_a is a feature amount matrix extracted from a signal of a piano sound. A matrix Y_b is a feature amount matrix extracted from a signal of a conversational voice. A matrix Y_c is a feature amount matrix extracted from a signal of a footstep. In the following, a signal source that generates a piano sound is referred to as an object signal source a. A signal source that generates a conversational voice is referred to as an object signal source b. A signal source that generates a footstep is referred to as an object signal source c.

The combination calculation unit 302 receives a learning feature amount from the second feature extraction unit 302. The combination calculation unit 302 may receive, for example, a learning feature amount matrix Y_0 from the second feature extraction unit 301. The combination calculation unit 302 calculates, from the received learning feature amount, a signal element basis and combination information. Specifically, the combination calculation unit 302 may decompose, as described below, a learning feature amount matrix Y_0 having K rows and L_0 columns into a signal element basis matrix G, a combination matrix C, and a weighting matrix H_0 in such a way that Y_0=GCH_0 is satisfied. A signal element basis matrix G is a matrix having K rows and F columns (K is the number of dimensions of a feature amount and F is the number of signal element bases). A value of F may be previously determined. A combination matrix C is a matrix having F rows and Q columns (F is the number of signal element bases and Q is the number of combinations). A weighting matrix H_0 is a matrix having Q rows and L_0 columns (Q is the number of combinations and L_0 is the number of time frames of Y_0).

A matrix G is a matrix in which F K-dimensional signal element bases are arranged. A matrix C is a matrix representing Q patterns of combination of F signal element bases and is set for each object signal source. It is assumed that, for example, an object signal source a, an object signal source b, and an object signal source c are modeled. When the number of variations of the object signal source a, the object signal source b, and the object signal source c is q(a), q(b), and q(c), respectively, Q=q(a)+q(b)+q(c) is satisfied (this corresponds to the number of bases R=n(1)+n(2)± . . . +n(S) described in the description of the prior art). The matrix C is represented as C=[C_a,C_b,C_c]. For example, a matrix C_a is a matrix having F rows and q(a) columns and is a matrix representing variations of an object signal source a by q(a) combination manners of F signal element bases. A matrix C_b is a matrix having F rows and q(b) columns and is a matrix representing variations of an object signal source b by q(b) combination manners of F signal element bases. A matrix C_c is a matrix having F rows and q(c) columns and is a matrix representing variations of an object signal source c by q(c) combination manners of F signal element bases. H_0 represents a weight of each object signal component included in Y_0 in each time frame of Y_0. A matrix H_0 is represented as below when a relation with the matrices C_a, C_b, and C_c is considered.

$${H}_{0} = [ \begin{matrix}{H}_{oa} \\ {H}_{0 b} \\ {H}_{0 c}\end{matrix} ] \qquad [ Math . 1 ]$$

Herein, H₀, H₀ₐ, H_{0b}, and H_{0c} each represent matrices H_0, H_0a, H_0b, and H_0c. Matrices H_0a, H_0b, and H_0c each are a matrix having q(a) rows and L_0 columns, a matrix having q(b) rows and L_0 columns, and a matrix having q(c) rows and L_0 columns. Y_0 is a learning feature amount matrix acquired by combining feature amount matrices each extracted from a plurality of object signals. A value of a weight, represented by H_0, of each object signal in each time frame (i.e., a value of each element of a matrix H_0) is already known.

A value of a weight of an object signal may be input to the signal separation device 300, for example, in a form of a weighting matrix, in addition to an object-signal-learning signal. The second reception unit 303 may receive a value of a weight of an object signal and transmit the received value of the weight of the object signal to the combination calculation unit 302 via the second feature extraction unit 301. Information identifying a signal source of a signal input as an object-signal-learning signal may be input, with respect to each time frame, to the second reception unit 303, together with an object-signal-learning signal. The second reception unit 303 may receive information identifying a signal source and transmit the received information identifying a signal source to the second feature extraction unit 301. The second feature extraction unit 301 may generate, based on the received information identifying a signal source, a weight for each object signal source represented, for example, by a weighting matrix. A value of a weight of an object signal may be previously input to the signal separation device 300. For example, the combination calculation unit 302 may store a value of a weight of an object signal. An object-signal-learning signal generated based on a value of a weight of an object signal previously stored may be input to the second reception unit 303 of the signal separation device 300.

As described above, the combination calculation unit 302 stores a matrix H_0 representing a value of a weight of each object signal in each time frame. Therefore, the combination calculation unit 302 may calculate a matrix G and a matrix C, based on a value of each of a matrix Y_0 and a matrix H_0. As a method of calculating a matrix G and a matrix C, for example, non-negative matrix factorization (NMF) using a cost function D_kl(Y_0, GCH_0) of a generalized KL-divergence criterion between Y_0 and GCH_0 is applicable. In an example described below, the combination calculation unit 302 calculates a matrix G and a matrix C as described below, based on the above-described NMF. The combination calculation unit 302 performs parameter update concurrently optimizing a matrix G and a matrix C in such a way as to minimize the cost function D_kl(Y_0, GCH_0). The combination calculation unit 302 sets, for example, a random value as an initial value of each element of G and C. The combination calculation unit 302 repeats calculation in accordance with the following update expression for a matrix G and a matrix C

$$G = G ∘ \frac{\frac{{Y}_{0}}{{GCH}_{0}} {( {CH}_{0} )}^{T}}{1 {( {CH}_{0} )}^{T}} \\ C = C ∘ \frac{{G}^{T} \frac{{Y}_{0}}{{GCH}_{0}} {H}_{0}^{T}}{{G}^{T} 1 {H}_{0}^{T}} \qquad [ Math . 2 ]$$

until calculation is repeated a predetermined number of repetitions or until a value of the cost function becomes equal to or smaller than a predetermined value. Specifically, the combination calculation unit 302 alternately repeats an update of a matrix G in accordance with the update expression for a matrix G and an update of a matrix C in accordance with the update expression for a matrix C and thereby calculates a matrix G and a matrix C. An operator ∘ represented by a circle in the above expression represents multiplication for each element of a matrix. A fraction of a matrix represents division for each element of a matrix, i.e., represents that a value of an element of a matrix in a numerator is divided by a value of an element of a matrix in a denominator with respect to each element of the matrix. Y₀ represents a matrix Y_0. A matrix 1 in math. 1 represents a matrix in which a size thereof is the same as Y_0 and a value of every element is 1. An acquired matrix G represents a signal element basis in which elements being bases of all object signals used for calculation are modeled. An acquired matrix C is a matrix representing the above-described combination information. In other words, a matrix C represents a combination manner for combining bases of a matrix G in such a way as to generate a signal corresponding to an object signal with respect to each of a plurality of object signals. The combination calculation unit 302 stores an acquired matrix G and matrix C in the signal information storage unit 102.

The feature extraction unit 101 according to the present example embodiment receives, as input, similarly to the feature extraction unit 101 according to the first example embodiment, a separation target signal x(t) and extracts a feature amount from the received separation target signal. The feature extraction unit 101 transmits, for example, a feature amount matrix Y having K rows and L columns representing the extracted feature amount to the analysis unit 103.

The analysis unit 103 according to the present example embodiment receives, for example, a feature amount matrix Y transmitted by the feature extraction unit 101 and in addition, reads a matrix G and a matrix C stored in the signal information storage unit 102. The analysis unit 103 stores, in the temporary storage unit 107, the matrix C (i.e., an initial value of the matrix C) read from the signal information storage unit 102. The analysis unit 103 calculates a matrix H in such a way that Y≈GCH is satisfied, by using the received matrix Y, the matrix G read from the signal information storage unit 102, and the matrix C stored in the temporary storage unit 107.

The analysis unit 103 further determines whether a predetermined condition is satisfied. When the predetermined condition is not satisfied, the analysis unit 103 updates a matrix C by using the calculated matrix H. The analysis unit 103 stores the updated matrix C in the temporary storage unit 107. The analysis unit 103 may repeatedly calculate a matrix H and update a matrix C until the predetermined condition is satisfied. A predetermined condition may indicate that, for example, the number of repetitions of calculation of a matrix H and update of a matrix C reaches a predetermined number. In other words, the analysis unit 103 may calculate a matrix H and update a matrix C until the number of repetitions of calculation of a matrix H and update of a matrix C reaches a predetermined number. A predetermined condition may indicate that, for example, a value of a cost function described below is equal to or smaller than a predetermined threshold. In other words, the analysis unit 103 may repeatedly calculate a matrix H and update a matrix C until a value of a cost function is equal to or smaller than a predetermined threshold. The analysis unit 103 may calculate a matrix H and update a matrix C until, for example, at least either of a condition that the number of repetitions of calculation of a matrix H and update of a matrix C reaches a predetermined number or a condition that a value of a cost function is equal to or smaller than a predetermined threshold is satisfied. A predetermined condition is not limited to the above examples. When a predetermined condition is satisfied, the analysis unit 103 transmits the calculated matrix H and matrix C to the combination unit 104.

A cost function may be, for example, a cost function D(Y, GCH)+μF(C) in which a restriction term F(C) for correcting a matrix C is added to a degree of similarity D(Y, GCH) between a matrix Y and a matrix CGH. The term μ in the cost function is a parameter representing an intensity of a restriction term. In this case, the analysis unit 103 may calculate a matrix H and update a matrix C in such a way as to minimize a cost function D(Y, GCH)+μF(C). As a degree of similarity D(Y, GCH), a degree of similarity D_kl(Y, GCH) of a generalized KL-divergence criterion between Y and GCH_0 is usable. As a cost function F(C), a degree of similarity D_kl(C₀, C) of a generalized KL-divergence criterion between C₀ and C is usable. In this case, an update expression of a matrix H is represented below.

$$H = H ∘ \frac{{( GC )}^{T} \frac{Y}{GCH}}{{( GC )}^{T} 1} \qquad [ Math . 3 ]$$

In math. 3, a matrix H of a right side is a matrix H before update, and a matrix H of a left side is a matrix H after update. An update expression of a matrix C is represented below.

$$C = C ∘ \frac{{G}^{T} \frac{Y}{GCH} {H}^{T} + μ \frac{{C}_{0}}{C}}{{G}^{T} 1 {H}^{T} + μ} \qquad [ Math . 4 ]$$

In math. 4, a matrix C₀ represents a matrix C before update, i.e., an initial value of a matrix C stored in the signal information storage unit 102. A matrix C of a right side is a matrix C before update, and a matrix C of a left side is a matrix C after update. A symbol μ in math. 4 may be scalar. The symbol μ may be a matrix having the same size as a matrix C. In this case, values of elements of a matrix μ may not necessarily be the same value. A term μC₀/C in math. 4 may indicate multiplication of elements of a matrix μ and a matrix C₀/C. Multiplication of elements of a first matrix and a second matrix indicates that, for example, with respect to i's and j's, a matrix including, as an element of an i-th column and a j-th row, a product of an element of an i-th column and a j-th row of a first matrix and an element of an i-th column and a j-th row of a second matrix is generated.

When a predetermined condition is not satisfied (e.g. a value of a cost function D(Y, GCH)+μF(C) is equal to or larger than a predetermined value), the analysis unit 103 updates a matrix C. Specifically, the analysis unit 103 updates a matrix C in accordance with math. 4, by using a matrix G and an initial value C₀ of a matrix C read from the signal information storage unit 102, a latest matrix C stored in the temporary storage unit 107, and a calculated matrix H. The analysis unit 103 stores the updated matrix C in the temporary storage unit 107.

The analysis unit 103 calculates a matrix H in accordance with math. 3, by using a matrix G stored in the signal information storage unit 102, the updated matrix C stored in the temporary storage unit 107, and a previously calculated matrix H. The analysis unit 103 determines whether a predetermined condition is satisfied (e.g. whether a value of a cost function D(Y, GCH)+μF(C) is smaller than a predetermined value). When the predetermined condition is not satisfied, the analysis unit 103 repeatedly updates a matrix C and calculates a matrix H. When the predetermined condition is satisfied, the analysis unit 103 transmits an acquired matrix H and matrix C to the combination unit 104.

The combination unit 104 receives a weighting matrix H and a combination matrix C transmitted from the analysis unit 103 and reads a signal element basis matrix G stored in the signal information storage unit 102. The combination unit 104 calculates, by using the weighting matrix H, the matrix G, and the matrix C, a separation signal, being a component of a signal generated from an object sound source, included in a target signal (i.e., a separation target signal according to the present example embodiment). The combination unit 104 combines, with respect to each object sound source, signal element bases in accordance with a combination method, and thereby generates a separation signal x_s(t) for each object sound source s and transmits the generated separation signal x_s(t) to the output unit 106. It is conceivable that, for example, a matrix Y_s represented by an expression Y_s=G·C_s·H_s using a combination C_s related to an object sound source s in a matrix C and a matrix H_s representing a weight corresponding to C_s in a matrix H is a component of a signal generated by an object sound source s in an input signal x(t). Therefore, a component x_s(t) of an object sound source s included in an input signal x(t) is acquired by applying, to Y_s, inverse conversion (e.g. inverse Fourier transform in a case of short-time Fourier transform) of feature amount conversion used for calculating a feature amount matrix Y by the feature extraction unit 101.

<Operation>

Next, an operation of the signal separation device 300 according to the present example embodiment is described in detail with reference to a drawing.

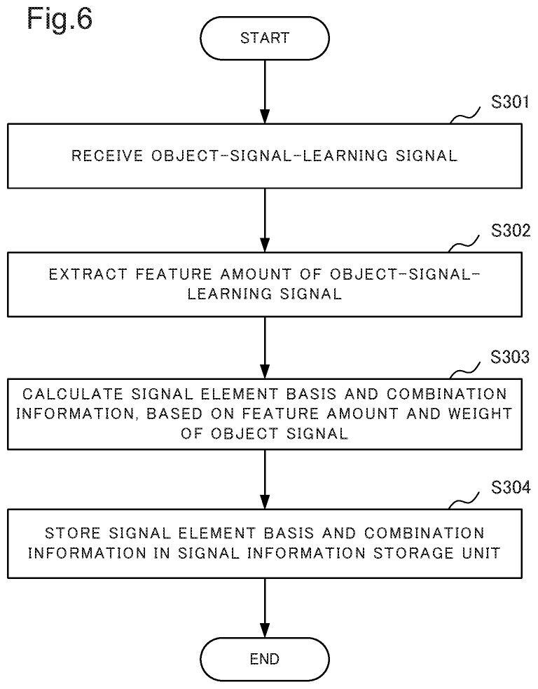

FIG. 6 is a flowchart illustrating an example of an operation of learning an object signal by the signal separation device 300 according to the present example embodiment.

According to FIG. 6, first, the second reception unit 303 receives an object-signal-learning signal (step S301). Next, the second feature extraction unit 301 extracts a feature amount of the object-signal-learning signal (step S302). The second feature extraction unit 301 may transmit the extracted feature amount to the combination calculation unit 302, for example, in a form of a feature amount matrix. The combination calculation unit 302 calculates a signal element basis and combination information, based on the extracted feature amount and a previously acquired value of a weight of an object signal (step S303). The combination calculation unit 302 may calculate, as described above, for example, based on a feature amount matrix and a weighting matrix representing a value of a weight, a signal element basis matrix representing a signal element basis and a combination matrix representing combination information. The combination calculation unit 302 stores the signal element basis and the combination information in the signal information storage unit 102 (step S304). The combination calculation unit 302 may store, for example, a signal element matrix representing a signal element basis and a combination matrix representing combination information in the signal information storage unit 102.

Next, an operation of separating an object signal in the signal separation device 300 according to the present example embodiment is described.

FIG. 2 is a flowchart illustrating an operation of separating an object signal by the signal separation device 300 according to the present example embodiment. An operation of separating an object signal by the signal separation device 300 according to the present example embodiment is the same as the operation of separating an object signal by the signal separation device 100 according to the first example embodiment.

### Advantageous Effect

The present example embodiment has, as a first advantageous effect, the same advantageous effect as the advantageous effect of the first example embodiment. The reason is the same as the reason why the advantageous effect of the first example embodiment is produced.

As described above, in a method of modeling, based on a feature amount basis, all variations of an object signal used in NPL 1 and the like, a feature amount basis matrix becomes larger as variations of an object signal increase, and therefore an enormous memory cost is required. According to the present example embodiment, an object signal is modeled as a combination of signal element bases each being a basis of a finer unit for expressing all object signals to be separated. Therefore, variations of an object signal are expressed as variations of a method of combining bases. Therefore, even when variations are increased, only a lower dimensional combination matrix may be increased, instead of a feature amount basis itself of an object signal. According to the present example embodiment, a memory cost lower than a required memory cost in the technique necessary in literature 1 is required.

In the prior art, for example, it is necessary to directly store, as a feature amount basis, variations of an object signal. Therefore, when 1000 variations of an object signal source are modeled by a basis of a number of feature amounts K=1000, information to be stored is, for example, a matrix having a number of bases corresponding to a feature amount basis matrix of 1000 rows and 10000 columns having 10000000 elements. However, according to the present example embodiment, variations of an object signal source are expressed by a combination matrix. Therefore, for example, under a condition of a number of feature amount dimensions K=1000 and a number of combinations Q=10000, for example, in a case of the number of signal element bases F=100, the numbers of elements of a matrix G and a matrix C each calculated by the combination calculation unit 302 and stored in the signal information storage unit 102 are K*F=100000 and F*Q=1000000. According to the present example embodiment, the number of elements to be stored is 1100000 and is one-ninth of the number of elements necessary to be stored according to the prior art. Therefore, according to the present example embodiment, as a second advantageous effect, there is an advantageous effect in that a basis and the like can be generated while a memory cost required for storing a basis in which a feature amount of a component of each object signal is modeled at low memory cost is reduced.

### Fourth Example Embodiment

Next, a signal detection device according to a fourth example embodiment of the present invention is described in detail with reference to drawings.

<Configuration>

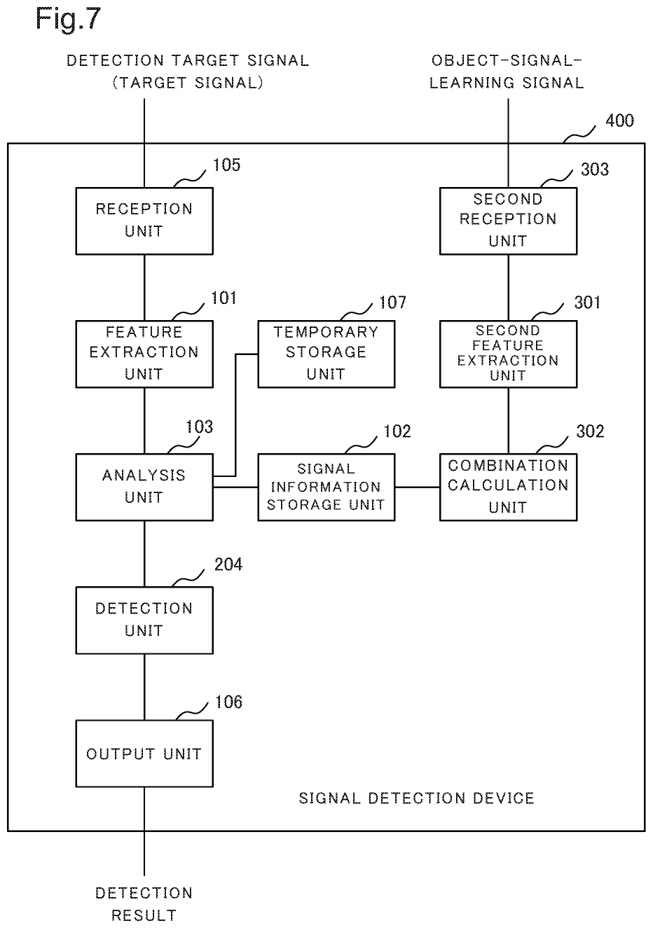

FIG. 7 is a block diagram illustrating an example of a configuration of a signal detection device 400 according to the present example embodiment. According to FIG. 7, the signal detection device 400 includes a feature extraction unit 101, a signal information storage unit 102, an analysis unit 103, a reception unit 105, a detection unit 204, an output unit 106, a temporary storage unit 107, a second feature extraction unit 301, a combination calculation unit 302, and a second reception unit 303. In comparison with the signal separation device 300 according to the third example embodiment illustrated in FIG. 5, the signal detection device 400 includes the detection unit 204, instead of a combination unit 104. The feature extraction unit 101, the signal information storage unit 102, the analysis unit 103, the reception unit 105, the detection unit 204, the output unit 106, and the temporary storage unit 107 according to the present example embodiment each are the same as a unit assigned with the same name and reference sign according to the second example embodiment. The second feature extraction unit 301, the combination calculation unit 302, and the second reception unit 303 according to the present example embodiment each are the same as a unit assigned with the same name and reference sign according to the third example embodiment.

Hereinafter, the detection unit 204 is specifically described.

The detection unit 204 receives, as input, a weighting matrix H representing a weight of an object signal transmitted by the analysis unit 103. The detection unit 204 detects, based on the weighting matrix H, an object signal included in a detection target signal. Each column of the weighting matrix H represents a weight of an object sound source included in any time frame of a feature amount matrix Y of a detection target signal. Therefore, the detection unit 204 may execute threshold processing for a value of each element of a matrix H and thereby detect an object signal included as a component in each time frame of Y. Specifically, the detection unit 204 may determine that, for example, when a value of an element of a matrix H is larger than a predetermined threshold, an object signal related to the element is included in a time frame indicated by a column including the element. The detection unit 204 may determine that, for example, when a value of an element of a matrix H is equal to or smaller than a predetermined threshold, an object signal related to the element is not included in a time frame indicated by a column including the element. In other words, the detection unit 204 may detect, for example, an element of a matrix H having a value larger than a threshold and detect an object signal related to the element, as an object signal included in a time frame indicated by an inferior including the detected element.

The detection unit 204 may detect an object signal included in each time frame of Y by using a discriminator using a value of each element of a matrix H as a feature amount. A discriminator may be, for example, a discriminator learned by using an SVM, a GMM or the like. The detection unit 204 may transmit, to the output unit 106, as a result of detection of an object signal, a matrix Z having S rows and L columns (S is the number of object signal sources and L is the total number of time frames of Y) in which each element represents presence or absence of an object signal source s in a time frame of Y by using 1 or 0. A value of an element of a matrix Z representing presence or absence of an object signal may be a score having a continuous value (e.g. a real value included between 0 to 1).

<Operation>

Next, an operation of the signal detection device 400 according to the present example embodiment is described in detail with reference to drawings.

FIG. 4 is a flowchart illustrating an example of an operation of detecting an object signal by the signal detection device 400 according to the present example embodiment. An operation of detecting an object signal in the signal detection device 400 is the same as the operation of the signal detection device 200 according to the second example embodiment illustrated in FIG. 4.

FIG. 6 is a flowchart illustrating an example of an operation of learning an object signal in the signal detection unit 400 according to the present example embodiment. An operation of learning in the signal detection unit 400 according to the present example embodiment is the same as the operation of learning in the signal separation device 300 according to the third example embodiment illustrated in FIG. 6.

### Advantageous Effect

The present example embodiment has, as a first advantageous effect, the same advantageous effect as the advantageous effect of the second example embodiment. The reason is the same as the reason why the advantageous effect of the second example embodiment is produced. The present example embodiment has, as a second advantageous effect, the same advantageous effect as the second advantageous effect of the third example embodiment. A reason why the advantageous effect is produced is the same as the reason why the second advantageous effect of the third example embodiment is produced.

### Fifth Example Embodiment

Next, a signal separation device according to a fifth example embodiment of the present invention is described in detail with reference to drawings.

<Configuration>

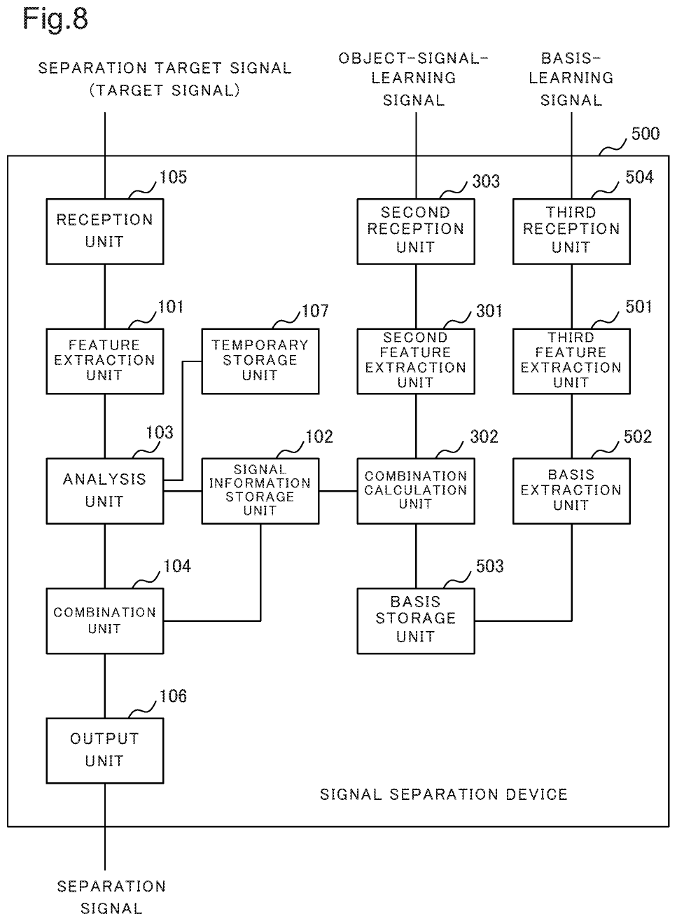

FIG. 8 is a block diagram illustrating an example of a configuration of a signal separation device 500 according to the present example embodiment. The signal separation device 500 includes, similarly to the signal separation device 100 according to the first example embodiment, a feature extraction unit 101, a signal information storage unit 102, an analysis unit 103, a combination unit 104, a reception unit 105, an output unit 106, and a temporary storage unit 107. The feature extraction unit 101, the signal information storage unit 102, the analysis unit 103, the combination unit 104, the reception unit 105, the output unit 106, and the temporary storage unit 107 according to the present example embodiment each are the same as a unit assigned with the same name and reference sign in the signal separation device 100 according to the first example embodiment. The signal separation device 500 further includes, similarly to the signal separation device 300 according to the third example embodiment, a second feature extraction unit 301, a combination calculation unit 302, and a second reception unit 303. The second feature extraction unit 301, the combination calculation unit 302, and the second reception unit 303 according to the present example embodiment each are the same as a unit assigned with the same name and reference sign in the signal separation device 300 according to the third example embodiment except a difference to be described later. The signal separation device 500 further includes a third feature extraction unit 501, a basis extraction unit 502, a basis storage unit 503, and a third reception unit 504.

The third reception unit 504 receives a basis-learning signal and transmits the received basis-learning signal to the third feature extraction unit 501. A basis-learning signal is described in detail later.

The third feature extraction unit 501 receives, as input, a basis-learning signal and extracts a feature amount from the received basis-learning signal. The third feature extraction unit 501 transmits, as a basis-learning feature amount matrix, the extracted feature amount to the basis extraction unit 502, for example, in a form of a matrix.

The basis extraction unit 502 receives a feature amount from the third feature extraction unit 501 and extracts a signal element basis from the received feature amount. Specifically, the basis extraction unit 502 extracts a signal element basis matrix from a basis-learning feature amount matrix received from the third feature extraction unit 501. The basis extraction unit 502 stores the extracted signal element basis matrix in the basis storage unit 503.

The basis storage unit 503 stores a signal element basis extracted by the basis extraction unit 502. Specifically, the basis storage unit 503 stores a signal element basis matrix transmitted by the basis extraction unit 502.

The combination calculation unit 302 calculates combination information, based on a feature amount extracted by the second feature extraction unit 301, a signal element basis stored in the basis storage unit 503, and a weight of an object signal. Specifically, the combination calculation unit 302 calculates a combination matrix, based on a feature amount matrix received from the second feature extraction unit 301, a signal element basis matrix stored in the basis storage unit 503, and a previously provided weighting matrix. The combination calculation unit 302 according to the present example embodiment may calculate a combination matrix by using the same method as the method of calculating a combination matrix by the combination calculation unit 302 according to the third example embodiment.

The third feature extraction unit 501 receives, as input, a basis-learning signal, extracts a feature amount from the received basis-learning signal, and transmits the extracted feature amount to the basis extraction unit 502. The third feature extraction unit 501 may transmit, to the basis extraction unit 502, a basis-learning feature amount matrix Y_g having K rows and L_g columns representing the extracted feature amount of the basis-learning signal. K is the number of dimensions of a feature amount and L_g is the total number of time frames of an input basis-learning signal. As described above, when a received signal is an acoustic signal, as a feature amount of a signal, an amplitude spectrum acquired by applying short-time Fourier transform to the signal is frequently used. A basis-learning signal is a signal for learning a basis used for representing an object signal to be separated as a separation signal. A basis-learning signal may be, for example, a signal including, as components, signals from all object signal sources to be separated as a separation signal. A basis-learning signal may be a signal in which, for example, signals from a plurality of object signal sources are temporally connected.

In a matrix Y_g, an object signal included in each time frame may not necessarily be determined. A matrix Y_g may include, as components, all object signals to be separated. A weight (e.g. the above-described weighting matrix) of a component of an object signal in each time frame of a matrix Y_g may not necessarily be acquired.

The basis extraction unit 502 receives, as input, a feature amount transmitted, for example, as a basis-learning feature amount matrix Y_g, by the third feature extraction unit 501. The basis extraction unit 502 calculates a signal element basis and a weight from the received feature amount. Specifically, the basis extraction unit 502 decomposes the received basis-learning feature amount matrix Y_g into a signal element basis matrix G being a matrix having K rows and F columns (K is the number of dimensions of a feature amount and F is the number of signal element bases) and a weighting matrix H_g having F rows and L_g columns (L_g is the number of time frames of the matrix Y_g). F may be previously determined appropriately. An expression representing decomposition of a matrix Y_g into a matrix G and a matrix H_g is represented as Y_g=GH_g.

Herein, a matrix G is a matrix in which F K-dimensional feature amount bases are arranged. A matrix H_g is a matrix representing a weight related to each signal element basis of G in each time frame of a matrix Y_g. As a method of calculating a matrix G and a matrix H_g, non-negative matrix factorization (NMF) using a cost function D_kl(Y_g, GH_g) of a generalized KL-divergence criterion between Y_g and GH_g is applicable. Hereinafter, an example using the NMF is described. The basis extraction unit 502 executing NMF updates a parameter in such a way as to concurrently optimize a matrix G and a matrix H_g minimizing a cost function D_kl(Y_g, GH_g). The basis extraction unit 502 sets, for example, a random value as an initial value of each element of a matrix G and a matrix H_g. The basis extraction unit 502 repeatedly updates a matrix G and a matrix H_g in accordance with the following update expressions for a matrix G and a matrix H_g

$$G = G ∘ \frac{\frac{{Y}_{g}}{{GH}_{g}} {H}_{g}^{T}}{1 {H}_{g}^{T}} \\ {H}_{g} = {H}_{g} ∘ \frac{{G}^{T} \frac{{Y}_{g}}{{GH}_{g}}}{{G}^{T} 1} \qquad [ Math . 5 ]$$

until update is repeated a predetermined number of times or until a value of the cost function becomes equal to or smaller than a predetermined value. A symbol ∘ in the above expression represents multiplication for each element of a matrix, and a fraction of a matrix represents division for each element of a matrix. Yg and Hg each represent a matrix Yg and a matrix H_g. The basis extraction unit 502 alternately repeatedly updates a matrix G and a matrix H_g and thereby acquires a matrix G and a matrix H_g. The acquired signal element basis matrix G can successfully represent Y_g including components of all object signals to be separated, i.e., the signal element basis matrix G is a basis being a base of components of all object signals to be separated. The basis extraction unit 502 stores the acquired matrix G in the basis storage unit 503.

The combination calculation unit 302 receives a feature amount of an object-signal-learning signal transmitted by the second feature extraction unit 301. Specifically, the combination calculation unit 302 receives a learning feature amount matrix Y_0. The combination calculation unit 302 reads a signal element basis stored in the basis storage unit 503. Specifically, the combination calculation unit 302 reads a signal element basis matrix G stored in the basis storage unit 503. The combination calculation unit 302 calculates combination information, based on a feature amount, a signal element basis, and a weight. Specifically, the combination calculation unit 302 calculates a combination matrix C when a matrix Y_0 is decomposed in such a way that Y_0=GCH_0 is satisfied, i.e., when a learning feature amount matrix Y_0 having K rows and L_0 columns is decomposed into a signal element basis matrix G, a combination matrix C, and a weighting matrix H_0. A signal element basis matrix G is a matrix having K rows and F columns (K is the number of dimensions of a feature amount and F is the number of signal element bases). A combination matrix C is a matrix having F rows and Q columns (F is the number of signal element bases and Q is the number of combinations). A weighting matrix H_0 is a matrix having Q rows and L_0 columns (Q is the number of combinations and L_0 is the number of time frames of Y_0). A method of calculating a combination matrix C is described in detail below.

Herein, a matrix C is a matrix representing Q patterns of combinations each combining F signal element bases. A combination is determined for each object signal. Similarly to the third example embodiment, a matrix H_0 is known. In other words, similarly to the combination calculation unit 302 according to the third example embodiment, the combination calculation unit 302 according to the present example embodiment holds, for example, as a matrix H_0, a weight of an object signal in an object-signal-learning signal. The combination calculation unit 302 reads a signal element basis matrix G from the basis storage unit 503. As described above, the combination calculation unit 302 according to the third example embodiment calculates a signal element basis matrix G and a combination matrix C. The combination calculation unit 302 of the present example embodiment calculates a combination matrix C. As a method of calculating a combination matrix C, non-negative matrix factorization (NMF) using a cost function D_kl(Y 0, GCH 0) of a generalized KL-divergence criterion between Y_0 and GCH 0 is applicable. Hereinafter, an example of a method of calculating a combination matrix C, based on the above-described NMF is described. The combination calculation unit 302 sets a random value as an initial value of each element of a matrix C. The combination calculation unit 302 repeats calculation in accordance with the following update expression for a matrix C

$$C = C ∘ \frac{{G}^{T} \frac{{Y}_{0}}{{GCH}_{0}} {H}_{0}^{T}}{{G}^{T} 1 {H}_{0}^{T}} \qquad [ Math . 6 ]$$

until calculation is repeated a predetermined number of times or until a value of a cost function becomes equal to or smaller than a predetermined value and thereby calculates a matrix C. An operator represented by ∘ in the above expression represents multiplication for each element of a matrix, and a fraction of a matrix represents division for each element of a matrix. A matrix 1 represents a matrix in which a size thereof is the same as Y_0 and a value of every element is 1. An acquired combination matrix C represents combination information representing a combination by which a signal element basis represented by a signal element basis matrix G stored in the basis storage unit 503 is combined in such a way as to acquire a signal corresponding to an object signal. The combination calculation unit 302 stores an acquired combination matrix C and a signal element basis matrix G read from the basis storage unit 503 in the signal information storage unit 102.

<Operation>

Next, an operation of the signal separation device 500 according to the present example embodiment is described in detail with reference to drawings.

FIG. 2 is a flowchart illustrating an operation of separating a signal by the signal separation device 500 according to the present example embodiment. An operation of separating a signal by the signal separation device 500 according to the present example embodiment is the same as the operation of separating a signal by the signal separation device 100 according to the first example embodiment.

FIG. 6 is a flowchart illustrating an operation of learning an object signal by the signal separation device 500 of the present example embodiment. An operation of learning an object signal by the signal separation device 500 according to the present example embodiment is the same as the operation of learning an object signal by the signal separation device 300 according to the third example embodiment.

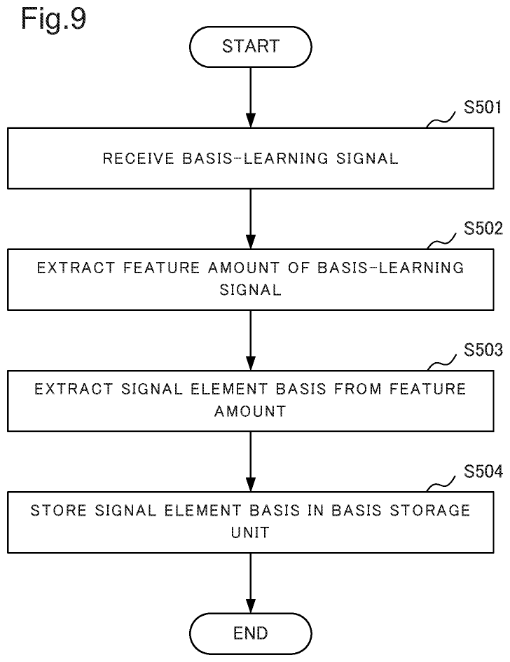

FIG. 9 is a flowchart illustrating an operation of learning a basis by the signal separation device 500 according to the present example embodiment.

According to FIG. 9, first, the third reception unit 504 receives a basis-learning signal (step S501). Next, the third feature extraction unit 501 extracts a feature amount of the basis-learning signal (step S502). The third feature extraction unit 501 may generate a feature amount matrix (i.e., a basis-learning feature amount matrix) representing the extracted feature amount. Next, the basis extraction unit 502 extracts a signal element basis from the extracted feature amount (step S503). The basis extraction unit 502 may calculate, as described above, a signal element basis matrix representing the signal element basis. Next, the basis extraction unit 502 stores, in the basis storage unit 503, the extracted signal element basis represented, for example, by a signal element basis matrix (step S504).

### Advantageous Effect

The present example embodiment has the same advantageous effects as the first advantageous effect and the second advantageous effect of the third example embodiment. The reason is similar to the reason why the advantageous effects of the third example embodiment are produced.

The present example embodiment has, as a third advantageous effect, an advantageous effect that accuracy in extraction of a signal element basis and combination information can be improved.

The basis extraction unit 502 according to the present example embodiment first calculates a signal element basis represented by a signal element basis matrix G. The combination calculation unit 302 calculates, by using the calculated signal element basis matrix G, a combination matrix C representing combination information. Therefore, it is unnecessary to calculate a solution to a concurrent optimization problem of two matrices (e.g. a matrix G and a matrix C) being a problem which is generally uneasy to calculate a solution accurately. Therefore, the signal separation device 500 according to the present example embodiment can accurately extract a matrix G and a matrix C, i.e., a signal element basis and combination information.

In other words, according to the present example embodiment, a signal element basis and combination information can be accurately extracted.

### Sixth Example Embodiment

Next, a signal detection device according to a sixth example embodiment of the present invention is described in detail with reference to drawings.

<Configuration>

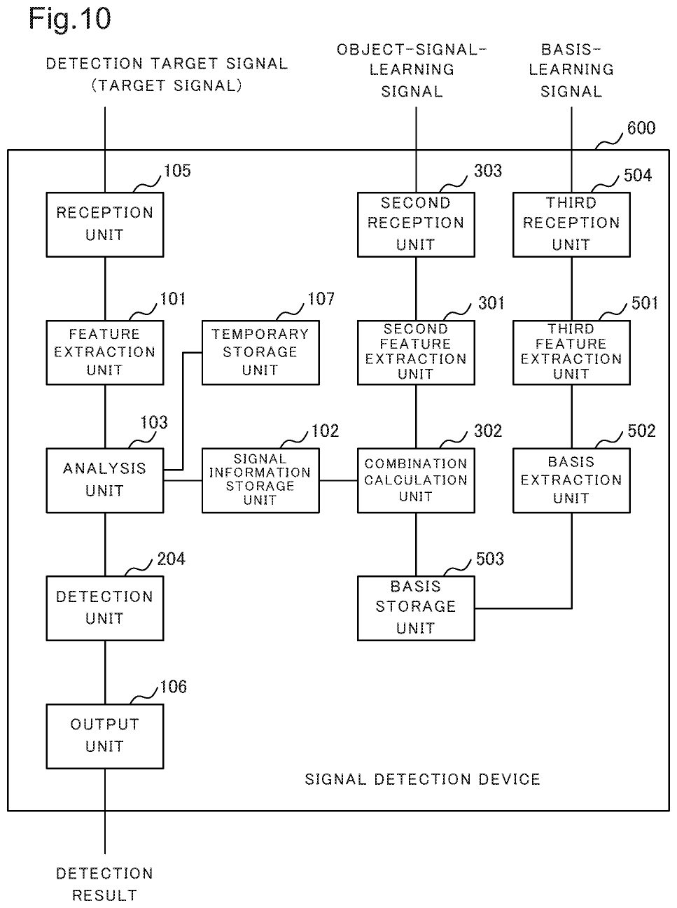

FIG. 10 is a diagram illustrating a configuration of a signal detection device 600 according to the present example embodiment. According to FIG. 10, the signal detection device 600 according to the present example embodiment includes a feature extraction unit 101, a signal information storage unit 102, an analysis unit 103, a reception unit 105, an output unit 106, a temporary storage unit 107, and a detection unit 204. The feature extraction unit 101, the signal information storage unit 102, the analysis unit 103, the reception unit 105, the output unit 106, the temporary storage unit 107, and the detection unit 204 according to the present example embodiment each are the same as a unit assigned with the same name and reference sign according to the second example embodiment. The signal detection device 600 further includes a second feature extraction unit 301, a combination calculation unit 302, and a second reception unit 303. The second feature extraction unit 301, the combination calculation unit 302, and the second reception unit 303 according to the present example embodiment each are the same as a unit assigned with the same notable site and reference sign according to the third example embodiment. The signal detection device 600 further includes a third feature extraction unit 501, a basis extraction unit 502, a basis storage unit 503, and a third reception unit 504. The third feature extraction unit 501, the basis extraction unit 502, the basis storage unit 503, and the third reception unit 504 according to the present example embodiment each are the same as a unit assigned with the same name and reference sign according to the fifth example embodiment.

<Operation>

Next, an operation of the signal detection device 600 according to the present example embodiment is described in detail with reference to drawings. FIG. 4 is a flowchart illustrating an operation of detecting an object signal by the signal detection device 600 according to the present example embodiment. An operation of detecting an object signal by the signal detection device 600 according to the present example embodiment is the same as the operation of detecting an object signal by the signal detection device 200 according to the second example embodiment.

FIG. 6 is a flowchart illustrating an operation of learning an object signal by the signal detection device 600 according to the present example embodiment. An operation of learning an object signal by the signal detection device 600 according to the present example embodiment is the same as the operation of learning an object signal by the signal separation device 300 according to the third example embodiment.

FIG. 9 is a flowchart illustrating an operation of learning a basis by the signal detection device 600 according to the present example embodiment. An operation of learning a basis by the signal detection device 600 according to the present example embodiment is the same as the operation of learning a basis by the signal detection device 500 according to the fifth example embodiment.

### Advantageous Effect

The present example embodiment has the same advantageous effects as the first advantageous effect and the second advantageous effect of the fourth example embodiment. The reason is the same as the reason why the first advantageous effect and the second advantageous effect of the fourth example embodiment are produced.

The present example embodiment further has the same advantageous effect as the third advantageous effect of the fifth example embodiment. The reason is the same as the reason why the third advantageous effect of the fifth example embodiment is produced.

### Seventh Example Embodiment

Next, a seventh example embodiment of the present invention is described in detail with reference to drawings.

<Configuration>

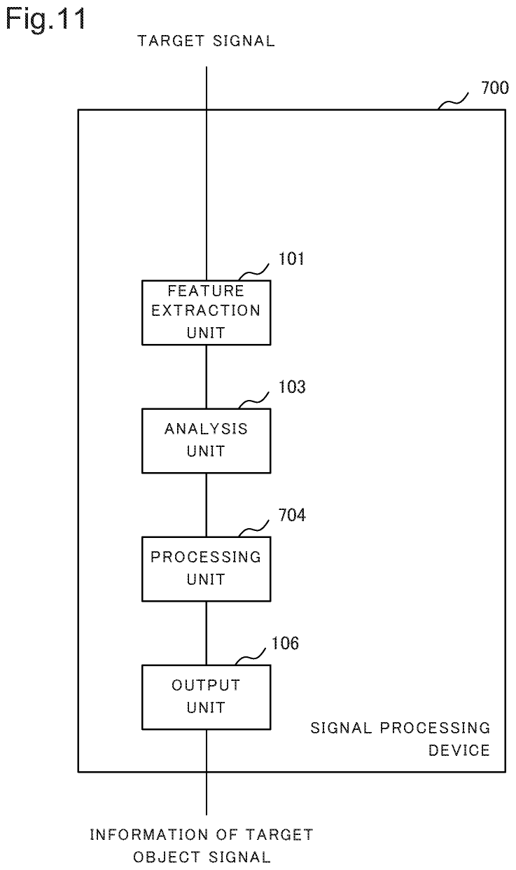

FIG. 11 is a block diagram illustrating an example of a configuration of a signal processing device 700 according to the present example embodiment.

According to FIG. 11, the signal processing device 700 includes a feature extraction unit 101, an analysis unit 103, a processing unit 704, and an output unit 106.

The feature extraction unit 101 extracts, from a target signal, a feature amount representing a feature of the target signal. The analysis unit 103 calculates, based on the extracted feature amount, a signal element basis representing a plurality of types of object signals by linear combination, and information of the linear combination, a weight representing an intensity of each of the plurality of object signals included in the target signal. The analysis unit 103 repeatedly calculates a weight and updates information of linear combination based on a feature amount, a signal element basis, and the calculated weight until a predetermined condition is satisfied. Information of linear combination is the above-described combination information. The processing unit 704 derives, based on the weight, information of a target object signal being at least one type of an object signal included in the target signal. The output unit 106 outputs the information of the target object signal.

The processing unit 704 may be, for example, the combination unit 104 included in a signal separation device according to the first, the third, and the fifth example embodiment. In this case, information of a target object signal is a separation signal of a target object signal. The processing unit 704 may be, for example, the detection unit 204 included in a signal separation device according to the second, the fourth, and the sixth example embodiment. In this case, information of a target object signal is, for example, information indicating whether a target object signal is included in each time frame of a target signal. Information of a target object signal may be, for example, information indicating a target object signal included in each time frame of a target signal.

<Operation>

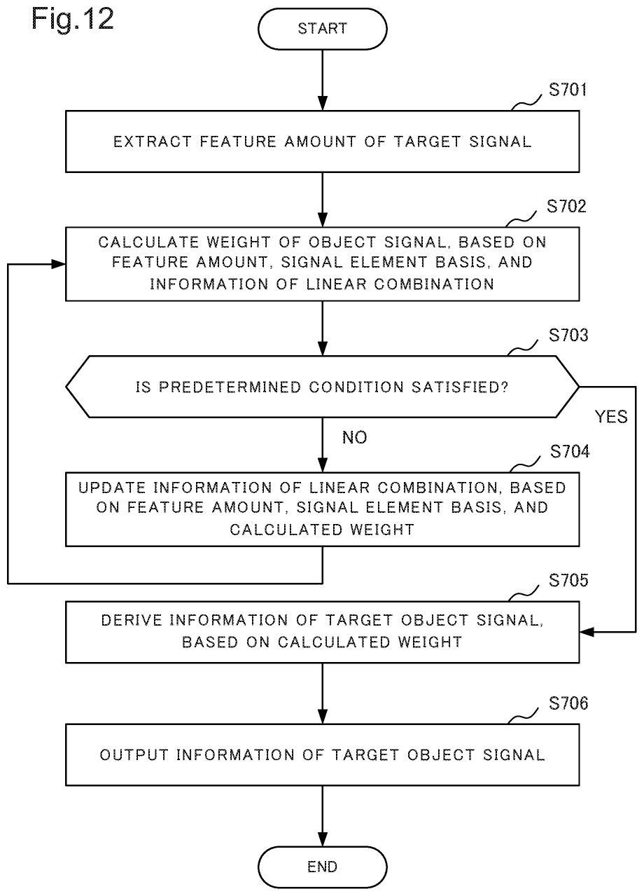

FIG. 12 is a flowchart illustrating an example of an operation of the signal processing device 700 according to the present example embodiment. According to FIG. 12, the feature extraction unit 101 extracts a feature amount of a target signal (step S701). Next, the analysis unit 103 calculates a weight representing an intensity of an object signal in the target signal, based on the extracted feature amount, a signal element basis, and information of linear combination of signal element bases (step S702). In step S702, the analysis unit 103 may calculate a weight, similarly to the analysis unit 103 according to the first, the second, the third, the fourth, the fifth, and the sixth example embodiment. The analysis 103 determines whether a predetermined condition is satisfied (step S703). When a predetermined condition is not satisfied (NO in step S703), the analysis unit 103 updates information of linear combination, based on an extracted feature amount, a signal element basis, and a calculated weight (step S704). An operation of the signal processing device 700 returns to an operation of step S702. When the predetermined condition is satisfied (YES in step S703), the processing unit 704 derives, based on the calculated weight, information of a target object signal (step S705). In step S705, the processing unit 704 may operate similarly to the combination unit 104 according to the first, the third, and the fifth example embodiment and derive, as information of a target object signal, a separation signal of a component of the target object signal. In step S705, the processing unit 703 may operate similarly to the detection unit 204 according to the second, the fourth, and the fifth example embodiment and derive, as information of a target object signal, information indicating whether the target object signal is included in a target signal. The output unit 106 outputs the derived information of the target object signal (step S706).

### Advantageous Effect

The present example embodiment has an advantageous effect that even when a variation of object signals is large, information of a component of a modeled object signal can be acquired at low memory cost. The reason is that a weight of an object signal is calculated, based on an extracted feature amount, a signal element basis representing a plurality of types of object signals by linear combination, and information of the linear combination. The processing unit 704 derives, based on the weight, information of a target object signal. A signal element basis representing a plurality of types of object signals by linear combination is used, and thereby a memory cost is reduced, relative to the prior art.

### Another Example Embodiment

While the present invention has been described with reference to example embodiments, the present invention is not limited to these example embodiments.

In the above description, a signal is an acoustic signal, but a signal is not limited to an acoustic signal. A signal may be a time-series temperature signal acquired from a temperature sensor. A signal may be a vibration signal acquired from a vibration sensor. A signal may be time-series data of a power consumption. A signal may be series data of a power consumption for each power user. A signal may be time-series data of a traffic density in a network. A signal may be time-series data of an air volume. A signal may be space-series data of a rainfall amount in a certain range. A signal may be other angle-series data or discrete series data such as a text and the like.

Series data are not limited to series data of an equal interval. Series data may be series data of an unequal interval.

In the above description, a method of decomposing a matrix is non-negative matrix factorization, but a method of decomposing a matrix is not limited to non-negative matrix factorization. As a method of decomposing a matrix, a method of decomposing a matrix such as ICA, PCA, SVD, and the like is applicable. A signal may not necessarily be returned to a form of a matrix. In this case, as a method of decomposing a signal, a signal compression method such as orthogonal matching pursuit, sparse coding, and the like is usable.

A device according to the example embodiments of the present invention may be achieved by a system including a plurality of devices. A device according to the example embodiments of the present invention may be achieved by a single device. An information processing program that achieves a function of a device according to the example embodiments of the present invention may be supplied directly or remotely to a computer included in a system or a computer being the above-described single device. A program installed in a computer in order to achieve, by using the computer, a function of a device according to the example embodiments of the present invention, a medium storing the program, and a world wide web (WWW) server in which the program is downloaded are also included in the example embodiments of the present invention. In particular, at least a non-transitory computer readable medium storing a program that causes a computer to execute processing included in the example embodiments described above is included in the example embodiments of the present invention.

Each of image generation devices according to the example embodiments of the present invention can be achieved by a computer including a memory loaded with a program and a processor executing the program, dedicated hardware such as a circuit and the like, and a combination of the above-described computer and dedicated hardware.

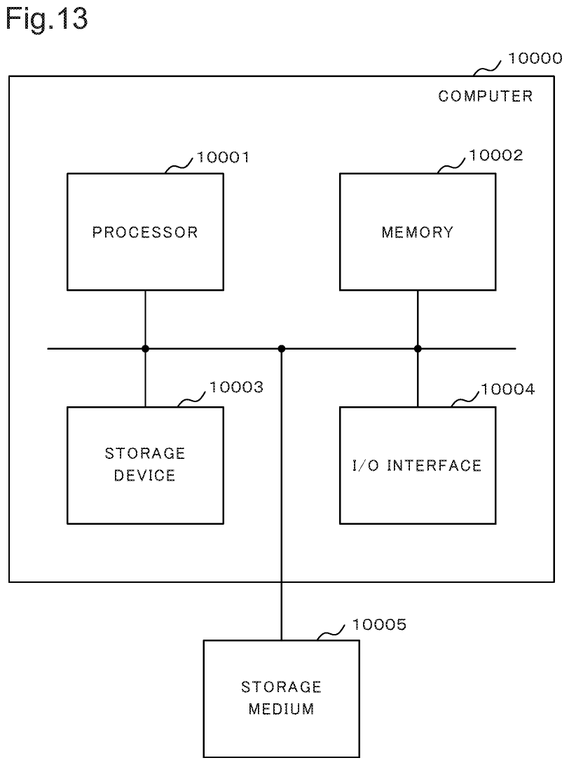

FIG. 13 is a block diagram illustrating an example of a hardware configuration of a computer capable of achieving a signal processing device according to the example embodiments of the present invention. The signal processing device may be, for example, the signal separation device 100 according to the first example embodiment. The signal processing device may be, for example, the signal detection device 200 according to the second example embodiment. The signal processing device may be, for example, the signal separation device 300 according to the third example embodiment. The signal processing device may be, for example, the signal detection device 400 according to the fourth example embodiment. The signal processing device may be, for example, the signal separation device 500 according to the fifth example embodiment. The signal processing device may be, for example, the signal detection device 600 according to the sixth example embodiment. The signal processing device may be, for example, the signal processing device 700 according to the seventh example embodiment. In the following description, a signal separation device, a signal detection device, and a signal processing device are collectively referred to as a signal processing device.

A computer 10000 illustrated in FIG. 13 includes a processor 10001, a memory 10002, a storage device 10003, and an input/output (I/O) interface 10004. The computer 10000 can access a storage medium 10005. The memory 10002 and the storage device 10003 are, for example, a random access memory (RAM) and a storage device such as a hard disk and the like. The storage medium 10005 is, for example, a RAM, a storage device such as a hard disk and the like, a read only memory (ROM), or a portable storage medium. The storage device 10003 may be the storage medium 10005. The processor 10001 can read/write data and a program from/to the memory 10002 and the storage device 10003. The processor 10001 can access, for example, a device being an output destination of information of a target object signal via the I/O interface 10004. The processor 10001 can access the storage medium 10005. The storage medium 10005 stores a program that causes the computer 10000 to operate as a signal processing device according to any one of the example embodiments of the present invention.

The processor 10001 loads, onto the memory 10002, a program, stored on the storage medium 10005, that causes the computer 10000 to operate as the above-described signal processing device. The processor 10001 executes the program loaded on the memory 10002 and thereby the computer 10000 operates as the above-described signal processing device.

The feature extraction unit 101, the analysis unit 103, the combination unit 104, the reception unit 105, and the output unit 106 can be achieved by the processor 10001 executing a dedicated program loaded on the memory 10002. The detection unit 204 can be achieved by the processor 10001 executing a dedicated program loaded on the memory 10002. The second feature extraction unit 301, the combination calculation unit 302, and the second reception unit 303 can be achieved by the processor 10001 executing a dedicated program loaded on the memory 10002. The third feature extraction unit 501, the basis extraction unit 502, and the third reception unit 504 can be achieved by the processor 10001 executing a dedicated program loaded on the memory 10002. The processing unit 704 can be achieved by the processor 10001 executing a dedicated program loaded on the memory 10002.

The signal information storage unit 102, the temporary storage unit 107, and the basis extraction unit 503 can be achieved by the memory 10002 and the storage device 10003 such as a hard disk device and the like included in the computer 10000.

Some or all of the feature extraction unit 101, the signal information storage unit 102, the analysis unit 103, the combination unit 104, the reception unit 105, the output unit 106, and the temporary storage unit 107 can be achieved by dedicated hardware such as a circuit. The detection unit 204 can be achieved by dedicated hardware such as a circuit. Some or all of the second feature extraction unit 301, the combination calculation unit 302, and the second reception unit 303 can be achieved by dedicated hardware such as a circuit. Some or all of the third feature extraction unit 501, the basis extraction unit 502, the basis storage unit 503, and the third reception unit 504 can be achieved by dedicated hardware such as a circuit. The processing unit 704 can be achieved by dedicated hardware such as a circuit.

A part or all of the example embodiments can be described as, but not limited to, the following supplementary notes.

(Supplementary Note 1)

A signal processing device including:

feature extraction means for extracting, from a target signal, a feature amount representing a feature of the target signal;

analysis means for repeatedly calculating, based on the extracted feature amount, a signal element basis representing a plurality of types of object signals by linear combination, and information of the linear combination, a weight representing an intensity of each of the plurality of object signals included in the target signal, and updating information of the linear combination, based on the feature amount, the signal element basis, and the weight, until a predetermined condition is satisfied;

processing means for deriving, based on the weight, information of a target object signal being at least one type of the object signal included in the target signal; and

output means for outputting information of the target object signal.

(Supplementary Note 2)

The signal processing device according to Supplementary Note 1, wherein

the processing means derives, based on the signal element basis, information of the linear combination, and the weight, as information of the target object signal, a separation signal representing a component of the target object signal included in the target signal.

(Supplementary Note 3)

The signal processing device according to Supplementary Note 1, wherein

the processing means derives, based on the weight, as information of the target object signal, whether the target object signal is included in the target signal.

(Supplementary Note 4)

The signal processing device according to any one of Supplementary Notes 1 to 3, further including

combination calculation means for calculating an initial value of information of the linear combination, based on an object-signal-learning feature amount being a feature amount extracted from an object-signal-learning signal including the plurality of types of object signals and a second weight representing an intensity of the plurality of types of object signals in the object-signal-learning signal.

(Supplementary Note 5)

The signal processing device according to Supplementary Note 4, wherein

the combination calculation means further calculates the signal element basis, based on the object-signal-learning feature amount.

(Supplementary Note 6)

The signal processing device according to Supplementary Note 4, further including

basis extraction means for extracting the signal element basis, based on a feature amount extracted from a basis-learning signal including the plurality of types of object signals, wherein

the combination calculation means calculates the initial value of information of the linear combination, based on the object-signal-learning feature amount, the second weight, and the extracted signal element basis.

(Supplementary Note 7)

A signal processing method including:

extracting, from a target signal, a feature amount representing a feature of the target signal;

repeatedly calculating, based on the extracted feature amount, a signal element basis representing a plurality of types of object signals by linear combination, and information of the linear combination, a weight representing an intensity of each of the plurality of object signals included in the target signal, and updating information of the linear combination, based on the feature amount, the signal element basis, and the weight, until a predetermined condition is satisfied;

deriving, based on the weight, information of a target object signal being at least one type of the object signal included in the target signal; and

outputting information of the target object signal.

(Supplementary Note 8)

The signal processing method according to Supplementary Note 7, further including

deriving, based on the signal element basis, information of the linear combination, and the weight, as information of the target object signal, a separation signal representing a component of the target object signal included in the target signal.

(Supplementary Note 9)

The signal processing method according to Supplementary Note 7, further including

deriving, based on the weight, as information of the target object signal, whether the target object signal is included in the target signal.

(Supplementary Note 10) The signal processing method according to any one of Supplementary Notes 7 to 9, further including

calculating an initial value of information of the linear combination, based on an object-signal-learning feature amount being a feature amount extracted from an object-signal-learning signal including the plurality of types of object signals and a second weight representing an intensity of the plurality of types of object signals in the object-signal-learning signal.

(Supplementary Note 11)

The signal processing method according to Supplementary Note 10, further including

calculating the signal element basis, based on the object-signal-learning feature amount.

(Supplementary Note 12)

The signal processing method according to Supplementary Note 10, further including:

extracting the signal element basis, based on a feature amount extracted from a basis-learning signal including the plurality of types of object signals; and

calculating the initial value of information of the linear combination, based on the object-signal-learning feature amount, the second weight, and the extracted signal element basis.

(Supplementary Note 13)

A storage medium storing a program causing a computer to execute:

feature extraction processing of extracting, from a target signal, a feature amount representing a feature of the target signal;

analysis processing of repeatedly calculating, based on the extracted feature amount, a signal element basis representing a plurality of types of object signals by linear combination, and information of the linear combination, a weight representing an intensity of each of the plurality of object signals included in the target signal, and updating information of the linear combination, based on the feature amount, the signal element basis, and the weight, until a predetermined condition is satisfied;

deriving processing of deriving, based on the weight, information of a target object signal being at least one type of the object signal included in the target signal; and

output processing of outputting information of the target object signal.

(Supplementary Note 14)

The storage medium according to Supplementary Note 13, wherein

the deriving processing derives, based on the signal element basis, information of the linear combination, and the weight, as information of the target object signal, a separation signal representing a component of the target object signal included in the target signal.

(Supplementary Note 15)

The storage medium according to Supplementary Note 13, wherein

the deriving processing derives, based on the weight, as information of the target object signal, whether the target object signal is included in the target signal.

(Supplementary Note 16)

The storage medium according to any one of Supplementary Notes 13 to 15, the program further causing a computer to execute

combination calculation processing of calculating an initial value of information of the linear combination, based on an object-signal-learning feature amount being a feature amount extracted from an object-signal-learning signal including the plurality of types of object signals and a second weight representing an intensity of the plurality of types of object signals in the object-signal-learning signal.

(Supplementary Note 17)

The storage medium according to Supplementary Note 16, wherein

the combination calculation processing further calculates the signal element basis, based on the object-signal-learning feature amount.

(Supplementary Note 18)

The storage medium according to Supplementary Note 16, the program further causing a computer to execute

basis extraction processing of extracting the signal element basis, based on a feature amount extracted from a basis-learning signal including the plurality of types of object signals, wherein

the combination calculation processing calculates the initial value of information of the linear combination, based on the object-signal-learning feature amount, the second weight, and the extracted signal element basis.

While the present invention has been described with reference to example embodiments, the present invention is not limited to these example embodiments. The constitution and details of the present invention can be subjected to various modifications which can be understood by those of ordinary skill in the art without departing from the scope of the present invention. A system or a device in which separate features included in the example embodiments are combined is also included in the scope of the present invention, regardless of a combination manner.

### REFERENCE SIGNS LIST

100 Signal separation device
101 Feature extraction unit
102 Signal information storage unit
103 Analysis unit
104 Combination unit
105 Reception unit
106 Output unit
107 Temporary storage unit
200 Signal detection device
204 Detection unit
300 Signal separation device
301 Second feature extraction unit
302 Combination calculation unit
303 Second reception unit
400 Signal detection device
500 Signal separation device
501 Third feature extraction unit
502 Basis extraction unit
503 Basis storage unit
504 Third reception unit
600 Signal detection device
700 Signal processing device
704 Processing unit
900 Signal separation device
901 Feature extraction unit
902 Basis storage unit
903 Analysis unit
904 Combination unit
905 Reception unit
906 Output unit
10000 Computer
10001 Processor
10002 Memory
10003 Storage device
10004 I/O interface
10005 Storage medium

What is claimed is:

1. A signal processing device comprising:
at least one memory storing a set of instructions; and
at least one processor configured to execute the set of instructions to:
extract, from a target signal, a feature amount representing a feature of the target signal;
repeatedly calculate, based on the extracted feature amount, a signal element basis representing a plurality of types of object signals by linear combination, and information of the linear combination, a weight representing an intensity of each of the plurality of object signals included in the target signal, and update information of the linear combination, based on the feature amount, the signal element basis, and the weight, until a predetermined condition is satisfied;
derive, based on the weight, information of a target object signal being at least one type of the object signal included in the target signal; and
output information of the target object signal.

2. The signal processing device according to claim 1, wherein
the at least one processor is further configured to execute the set of instructions to
derive, based on the signal element basis, information of the linear combination, and the weight, as information of the target object signal, a separation signal representing a component of the target object signal included in the target signal.

3. The signal processing device according to claim 1, wherein
the at least one processor is further configured to execute the set of instructions to
derive based on the weight, as information of the target object signal, whether the target object signal is included in the target signal.

4. The signal processing device according to claim 1, wherein
the at least one processor is further configured to execute the set of instructions to
calculate an initial value of information of the linear combination, based on an object-signal-learning feature amount being a feature amount extracted from an object-signal-learning signal including the plurality of types of object signals and a second weight representing an intensity of the plurality of types of object signals in the object-signal-learning signal.

5. The signal processing device according to claim 4, wherein
the at least one processor is further configured to execute the set of instructions to
calculate the signal element basis, based on the object-signal-learning feature amount.

6. The signal processing device according to claim 4, further comprising
the at least one processor is further configured to execute the set of instructions to:
extract the signal element basis, based on a feature amount extracted from a basis-learning signal including the plurality of types of object signals; and
calculate the initial value of information of the linear combination, based on the object-signal-learning feature amount, the second weight, and the extracted signal element basis.

7. A signal processing method comprising:
extracting, from a target signal, a feature amount representing a feature of the target signal;
repeatedly calculating, based on the extracted feature amount, a signal element basis representing a plurality of types of object signals by linear combination, and information of the linear combination, a weight representing an intensity of each of the plurality of object signals included in the target signal, and updating information of the linear combination, based on the feature amount, the signal element basis, and the weight, until a predetermined condition is satisfied;
deriving, based on the weight, information of a target object signal being at least one type of the object signal included in the target signal; and
outputting the-information of the target object signal.

8. The signal processing method according to claim 7, further comprising
deriving, based on the signal element basis, information of the linear combination, and the weight, as information of the target object signal, a separation signal representing a component of the target object signal included in the target signal.

9. The signal processing method according to claim 7, further comprising
deriving, based on the weight, as information of the target object signal, whether the target object signal is included in the target signal.

10. The signal processing method according to claim 7, further comprising
calculating an initial value of information of the linear combination, based on an object-signal-learning feature amount being a feature amount extracted from an object-signal-learning signal including the plurality of types of object signals and a second weight representing an intensity of the plurality of types of object signals in the object-signal-learning signal.

11. The signal processing method according to claim 10, further comprising
calculating the signal element basis, based on the object-signal-learning feature amount.

12. The signal processing method according to claim 10, further comprising:
extracting the signal element basis, based on a feature amount extracted from a basis-learning signal including the plurality of types of object signals; and
calculating the initial value of information of the linear combination, based on the object-signal-learning feature amount, the second weight, and the extracted signal element basis.

13. A non-transitory computer readable storage medium storing a program causing a computer to execute:
feature extraction processing of extracting, from a target signal, a feature amount representing a feature of the target signal;
analysis processing of repeatedly calculating, based on the extracted feature amount, a signal element basis representing a plurality of types of object signals by linear combination, and information of the linear combination, a weight representing an intensity of each of the plurality of object signals included in the target signal, and updating information of the linear combination, based on the feature amount, the signal element basis, and the weight, until a predetermined condition is satisfied;
deriving processing of deriving, based on the weight, information of a target object signal being at least one type of the object signal included in the target signal; and
output processing of outputting information of the target object signal.

14. The storage medium according to claim 13, wherein
the deriving processing derives, based on the signal element basis, information of the linear combination, and the weight, as information of the target object signal, a separation signal representing a component of the target object signal included in the target signal.

15. The storage medium according to claim 13, wherein
the deriving processing derives, based on the weight, as information of the target object signal, whether the target object signal is included in the target signal.

16. The storage medium according to claim 13, the program further causing a computer to execute
combination calculation processing of calculating an initial value of information of the linear combination, based on an object-signal-learning feature amount being a feature amount extracted from an object-signal-learning signal including the plurality of types of object signals and a second weight representing an intensity of the plurality of types of object signals in the object-signal-learning signal.

17. The storage medium according to claim 16, wherein
the combination calculation processing further calculates the signal element basis, based on the object-signal-learning feature amount.

18. The storage medium according to claim 16, the program further causing a computer to execute
basis extraction processing of extracting the signal element basis, based on a feature amount extracted from a basis-learning signal including the plurality of types of object signals, wherein
the combination calculation processing calculates the initial value of information of the linear combination, based on the object-signal-learning feature amount, the second weight, and the extracted signal element basis.
